(19) United States
(12) Patent Application Publication
(10) Pub. No.: US 2003/0227913 A1
(43) Pub. Date: Dec. 11, 2003

(54) Adaptive timing recovery of synchronous transport signals

(75) Inventors: Edward H. Hallman, Brookfield, CT (US); Leigh David Danenberg, Woodbury, CT (US); Donald Richard Brown III, Lunenburg, MA (US); Thomas K. Johnson, Watertown, CT (US)

Correspondence Address: TESTA, HURWITZ & THIBEAULT, LLP, HIGH STREET TOWER, 125 HIGH STREET, BOSTON, MA, 02110, US

(73) Assignee: LITCHFIELD COMMUNICATIONS, INC., WATERTOWN, CT

(21) Appl. No.: 10/163,134

(22) Filed: Jun. 5, 2002

(51) Int. Cl. H04L 12/50; H04J 3/06

(52) U.S. Cl. 370/374; 370/350

(57) ABSTRACT

One aspect of the present invention provides a process and a system for emulating a synchronous transport signal across a packet-oriented network. The process includes the steps of receiving a data representative of a synchronous transport signal at each of several channel processors, creating a number of packets, each having a header conforming to the protocol of a packet-oriented network, and transmitting the packets via the packet-oriented network. In addition, the process also includes the steps of storing each of these packets in a set of memory elements associated with each of the channel processors and adjusting timing of the synchronous transport signal based on the packet-count telemetry associated with each of the memory elements.

### FIELD OF THE INVENTION

The present invention relates generally to telecommunications and more specifically to emulation of telecommunications signals over a packet-oriented network.

### BACKGROUND OF THE INVENTION

Technological advances in telecommunications infrastructure continue to expand bandwidth capacity, allowing greater amounts of information to be transferred at faster rates. Improvements in the stability of telecommunications channels also support large-scale synchronous communications. A synchronous digital hierarchy (SDH) is now replacing the asynchronous digital hierarchy providing increased bandwidth with other advantages, such as add/drop multiplexing. Standards bodies have developed interoperability standards to capitalize on these advances by facilitating regional, national and even global communications. For example, the synchronous optical network (SONET) standard formulated by the Exchange Carriers Standards Association (ECSA) for the American National Standards Institute (ANSI) supports optical communications at bandwidths up to 10 gigabits-per-second.

Technological advances in networking infrastructure continue to expand network capacity, allowing greater amounts of information to be transferred among more users at faster rates. The Internet is a global network leveraging existing world-wide communications infrastructures to provide data connectivity between virtually any two locations serviced by telephone. The packet-oriented nature of these networks allows communication between locations without requiring a dedicated circuit. As a result, bandwidth capacity not being used by one communicator remains available to another. Technological advances in the networking area have also resulted in increased bandwidth as new applications offer streaming media (e.g., radio and video).

In order to emulate a synchronous transport signal after transporting it across a packet-oriented network, the rigid timing characteristic of the synchronous transport signal require that its prior timing adjustments (or timing information) be replicated or conveyed at a receiving end of the packet-oriented network. For example, for a SONET signal, if either a positive or a negative timing adjustment occurs in its originating SONET path, that information must be conveyed across the packet-oriented network, so that the same pointer adjustment can be performed on the other side of the SONET path at the receiving end of the packet-oriented network. Unfortunately, such transmission across the packet-oriented network results in intolerable variable delays, especially when using different network paths to deliver various data streams. Because the timing information from the synchronous transport signal does not account for the variable delays, such timing information alone would not reconstruct (or emulate) the synchronous transport signal in its original synchronous format.

Some systems use adaptive methods to synchronize a timing signal at a receiver from a received signal (e.g., ATM Adaptation Layer (AAL1)). Generally, the timing information may be obtained from the received bit rate, frame rate, or cell rate. These approaches, however are not well suited for reception of packets received over a packet switched network, such as the Internet. In a packet network, each packet is generally received with a variable delay such that some packets may be received in an order other than the order in which they were transmitted. Thus, operation of these prior art systems in a packet-switched environment will likely result in timing errors.

### SUMMARY OF THE INVENTION

The present invention facilitates emulation of synchronous transport signals by providing an enhanced timing adjustment process that accounts for the variable delays that incur from a packet-oriented network. Instead of solely relying on the timing information from the synchronous transport signals, the present invention provides an alternative timing adjustment process and a system that accounts for such variable delays.

In general, one aspect of the invention relates to a process for emulating a synchronous transport signal across a packet-oriented network. One step of this process is receiving data representative of a synchronous transport signal, such as a SONET signal, at each of several channel processors. The channel processors may include physical channel processors, logical channel processors, or a combination of both processors.

The process also includes the step of creating a number of packets. The packets may conform to the protocol of an IP network. The packets may also conform to other types of packet-switched-network protocols, such as PPP, MPLS, ATM, Ethernet, RPR, and GFP.

Additional steps of the process include transmitting the packets via the packet-oriented network and storing each of these packets in a set of memory elements, such as ring buffers, associated with each of the channel processors.

Another step of the process is adjusting the timing of the synchronous transport signal, such as the SONET signal, based on telemetry data representative of one or more packet counts. More specifically, the adjusting step counts a number of packets written into the memory, a number of packets played out of the memory element, and a number of packets lost in transit. Furthermore, the adjusting step processes the telemetry data to determine a timing adjust signal, and then, makes a pointer adjustment, e.g., positive pointer adjustment or a negative pointer adjustment, for the SONET signal based on this timing adjust signal. The adjusting step can include digital signal processing. In one embodiment, digital signal processing is based on a series lead compensator with a negative unity output feedback, wherein the series lead compensator is configured by a plurality of parameters. In addition, digital signal processing comprises an acquisition mode, a tracking mode, and a holdover mode; the acquisition mode allows for a rapid acquisition of synchronization at startup, the tracking mode provides for substantial noise rejection during steady-state operation, and the holdover mode refrains from processing new data.

Alternatively, the adjusting step processes the telemetry data to determine a timing adjust signal, and then, controls a controllable timing source based on the timing adjust signal. For example, the adjusting step controls a controllable timing source by providing a voltage control signal to a Voltage Controlled Frequency Oscillator (VCXO). The adjusting step can also convert the timing adjust signal from digital signal to analog signal.

Another aspect of the invention relates to an apparatus for emulating a synchronous transport signal across a packet-oriented network. The system includes several channel processors, each receiving a synchronous transport signal and a packet processor to create a multiple packets, each having a header conforming to the protocol of a packet-oriented network. The system also includes a transmitter to transmit the packets over the packet-oriented network and several memory elements to store each of the received packets associated with each of the channel processors.

In addition, the system includes a timing adjuster to adjust the timing of the synchronous transport signal based on telemetry data representative of a packet count selected from packets received, played, and dropped, while accounting for mis-ordered packets. The timing adjuster also includes a counter counting the selected packets, a Digital Signal Processor (DSP) that periodically receives a number of packets counted and generates a timing adjust signal based on the received packet count. In addition, the timing adjuster includes a Voltage-Controlled Frequency Oscillator (VCXO) that receives the timing adjust signal from the DSP. Furthermore, the timing adjuster comprises a Digital-To-Analog Converter (DAC) that receives the timing adjust signal from the DSP and transmits an analog representation of the timing adjust signal to the VCXO.

### BRIEF DESCRIPTION OF THE DRAWINGS

The invention is pointed out with particularity in the appended claims. The advantages of the invention may be better understood by referring to the following description taken in conjunction with the accompanying drawing in which:

FIG. 1 is a diagram depicting an embodiment of a STS-1 frame as known to the Prior Art;

FIG. 2 is a diagram depicting a relationship between an STS-1 Synchronous Payload Envelope and the STS-1 frame shown in FIG. 1 as known to the Prior Art;

FIG. 3 is a diagram depicting an embodiment of an interleaved STS-3 frame as known to the Prior Art;

FIG. 4 is a diagram depicting an embodiment of a concatenated STS-3(c) frame as known to the Prior Art;

FIG. 5 is a diagram depicting an embodiment of positive byte stuffing as known to the Prior Art;

FIG. 6 is a diagram depicting an embodiment of negative byte stuffing as known to the Prior Art;

FIG. 7 is a block diagram depicting an embodiment of the invention;

FIG. 8 is a more-detailed block diagram depicting the embodiment shown in FIG. 7;

FIG. 9 is a block diagram depicting an embodiment of the SONET Receive Telecom Bus Interface (SRTB) shown in FIG. 8;

FIG. 10 is a block diagram depicting an embodiment of the Time-Slot Interchange (TSI) shown in FIG. 9;

FIG. 11 is a block diagram depicting an embodiment of the SONET Receive Frame Processor (SRFP) shown in FIG. 8;

FIG. 12 is a block diagram depicting an embodiment of the time-slot decoder shown in FIG. 11;

FIG. 13 is a block diagram depicting an embodiment of the receive Channel Processor shown in FIG. 11;

FIG. 14 is a block diagram of an embodiment of the buffer memory associated with the Packet Buffer Manager (PBM) shown in FIG. 8;

FIG. 15 is a functional block diagram depicting an embodiment of the Packet Transmitter shown in FIG. 7;

FIG. 16 is a functional block diagram depicting an embodiment of a transmit segmenter in the packet transmit processor;

FIG. 17 is a functional block diagram depicting an embodiment of the Packet Transmit Interface (PTI) shown in FIG. 8;

FIG. 18 is functional block diagram depicting an embodiment of an external interface system in the PTI;

FIG. 19 is functional block diagram depicting an embodiment of the packet receive system shown in FIG. 7;

FIG. 20 is more-detailed schematic diagram depicting an embodiment of a FIFO entry for the Packet Receive Processor (PRP) Receive FIFO shown in FIG. 19;

FIG. 21 is functional block diagram depicting an embodiment of the packet receive DMA (PRD) engine shown in FIG. 8;

FIG. 22 is functional block diagram depicting an embodiment of the Jitter Buffer Manager (JBM) shown in FIG. 8;

FIG. 23A is a more-detailed block diagram of an embodiment of the jitter buffer associated with the JBM shown in FIG. 8;

FIG. 23B is a schematic diagram depicting an embodiment of a description from the descriptor ring shown in FIG. 23A;

FIG. 24 is a functional block diagram depicting an embodiment of a descriptor access sequencer (DAS) shown in FIG. 22;

FIG. 25A is a state diagram depicting an embodiment of the jitter buffer in a static configuration;

FIG. 25B is a state diagram depicting an embodiment of the jitter buffer in a dynamic configuration;

FIG. 26A is a block diagram depicting an embodiment of the Synchronous Transmit DMA Engine (STD) shown in FIG. 8;

FIG. 26B is a block diagram depicting an alternative embodiment of the Synchronous Transmit DMA Engine (STD) shown in FIG. 8;

FIG. 27 is a block diagram depicting an embodiment of the SONET Transmit Frame Processor (STFP) shown in FIG. 8;

FIG. 28 is a block diagram depicting an embodiment of the SONET transmit Channel Processor shown in FIG. 27;

FIG. 29 is a block diagram depicting an embodiment of the SONET Transmit Telecom Bus (STTB) shown in FIG. 8; and

FIGS. 30A through 30C are schematic diagrams depicting an exemplary telecom signal data stream processed by an embodiment of the channel processor shown in FIG. 13.

### DETAILED DESCRIPTION OF THE INVENTION

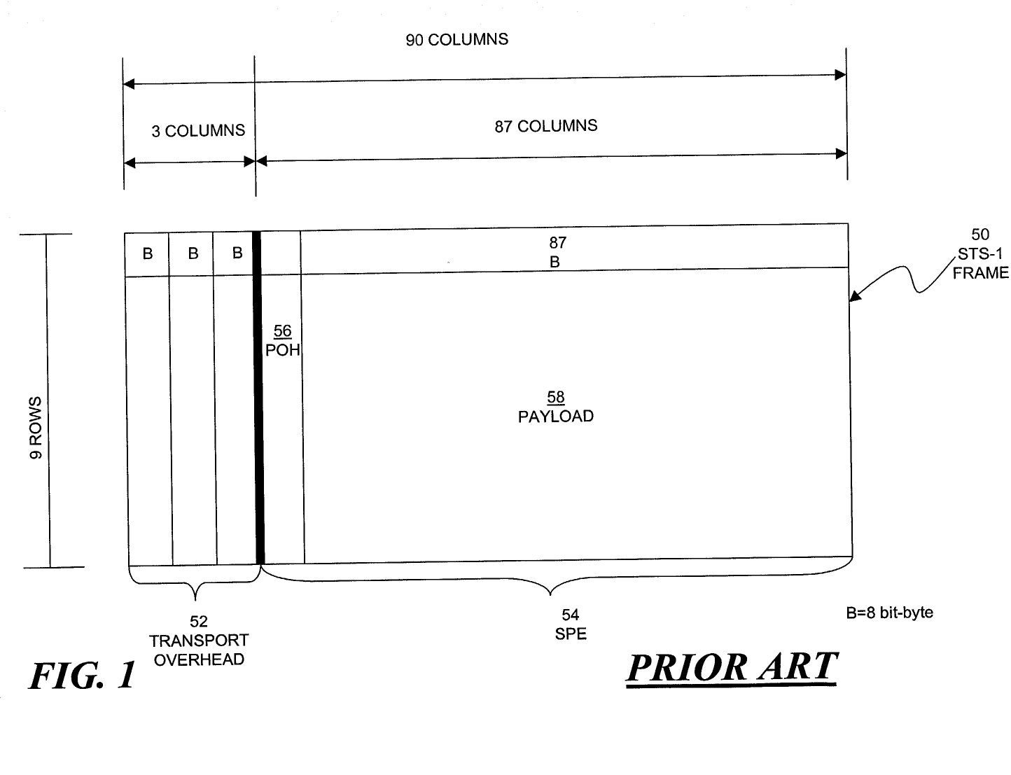

SONET (Synchronous Optical Network), as a standard for optical telecommunications, defines a technology for carrying many signals of different capacities through a synchronous and optical hierarchy by means of multiplexing schemes. The SONET multiplexing schemes first generate a base signal, referred to as STS-1, or Synchronous Transport Signal Level-1, operating at 51.84 Mbits/s. STS-N represents an electrical signal that is also referred to as an OC-N optical signal when modulated over an optical carrier. Referring to FIG. 1, one STS-1 Frame 50′ divides into two sections: (1) Transport Overhead 52 and (2) Synchronous Payload Envelope (SPE) 54. The STS-1 Frame 50′ comprises of 810 bytes, typically depicted as a 90 column by 9 row structure. Referring again to FIG. 1, the first three “columns” (or bytes) of the STS-1 Frame 50′ constitute the Transport Overhead 52. The remaining eighty-seven “columns” constitute the SPE 54. The SPE 54 includes (1) one column of STS Path Overhead 56 (POH) and (2) eighty-six columns of Payload 58, which is the data being transported over the SONET network after being multiplexed into the SPE 54. The order of transmission of bytes in the SPE 54 is row-by-row from top to bottom.

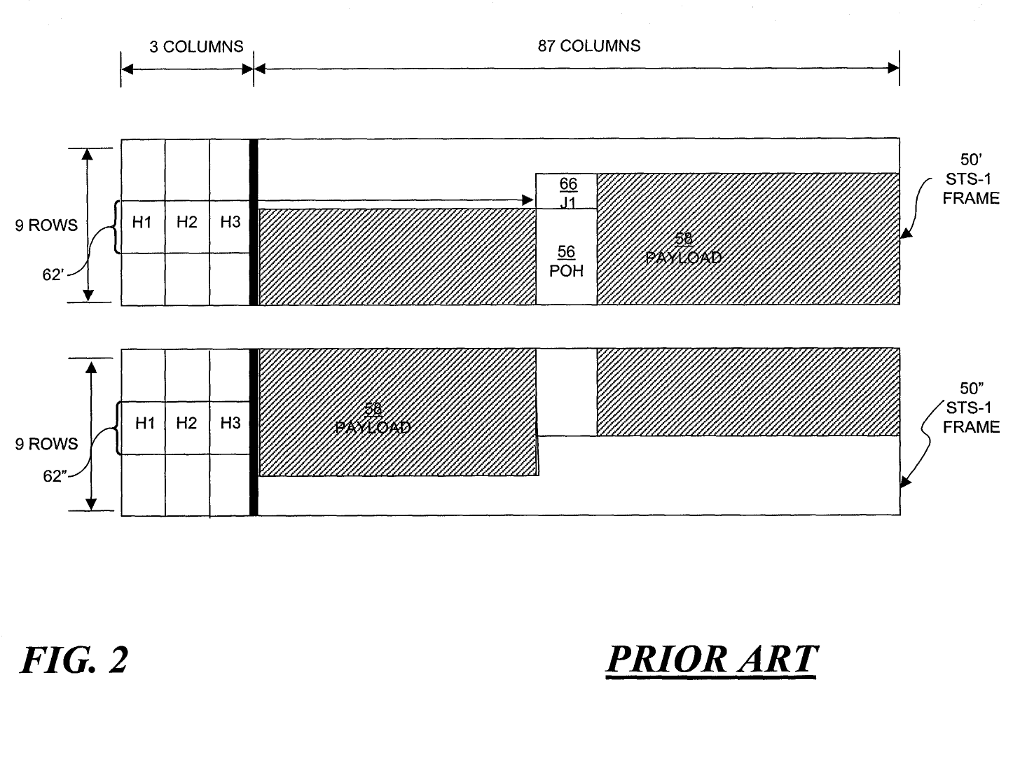

Referring to FIG. 2 (and FIG. 1 for reference), the STS-1 SPE 54 may begin anywhere after the three columns of the Transport Overhead 52 in the STS-1 Frame 50′, meaning the STS-1 SPE 54 may begin in one STS-1 Frame 50′ and end in the next STS-1 Frame 50″. An STS Payload Pointer 62, occupies bytes H1 and H2 in the Transport Overhead 52, designating the starting location of the STS-1 Payload 58 and signaled by a J1 byte 66. Accordingly, the payload pointer 62 allows the STS-1 SPE to float within a STS-N Frame under synchronized clocking.

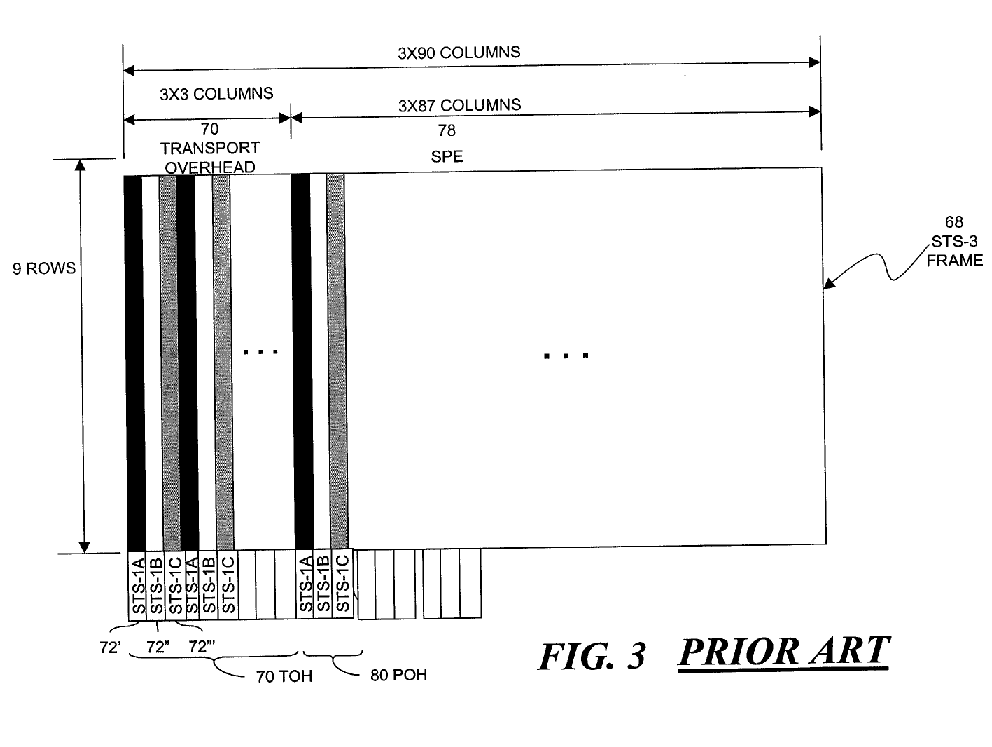

Transmission rates higher than STS-1 are achieved by generating a higher level signal, STS-N, by byte-interleaved multiplexing or concatenation. A STS-N signal represents N byte-interleaved STS-1 signals operating at N multiples of the base signal transmission rate. A STS-N frame comprises N×810 bytes, and thus can be structured with the Transport Overhead comprising N×3 columns by 9 rows, and the SPE comprising N×87 columns by 9 rows. Because STS-N is formed by byte interleaving STS-1 Frames 50, each STS-1 Frame 50′ includes the STS Payload Pointer 62 indicating the starting location of the SPE 54. For example, referring to FIG. 3, an STS-3 operates at 155.52 Mbits/s, three times the transmission rate of STS-1. An STS-3 Frame 68 can be depicted as a 270 columns by 9 row structure. The first 9 columns contain a Transport Overhead 70 representing the interleaved or sequenced Transport Overhead bytes from each of the contributing STS-1 signals: STS-1A 72′ (shown in black); STS-1B 72″ (shown in white); and STS-1C 72′″ (shown in gray). The remaining 261 columns of the STS-3 SPE 78 represents the interleaved bytes of the POH 80 and the payload from STS-1A 72′, STS-1B 72″, and STS-1C 72′″, respectively.

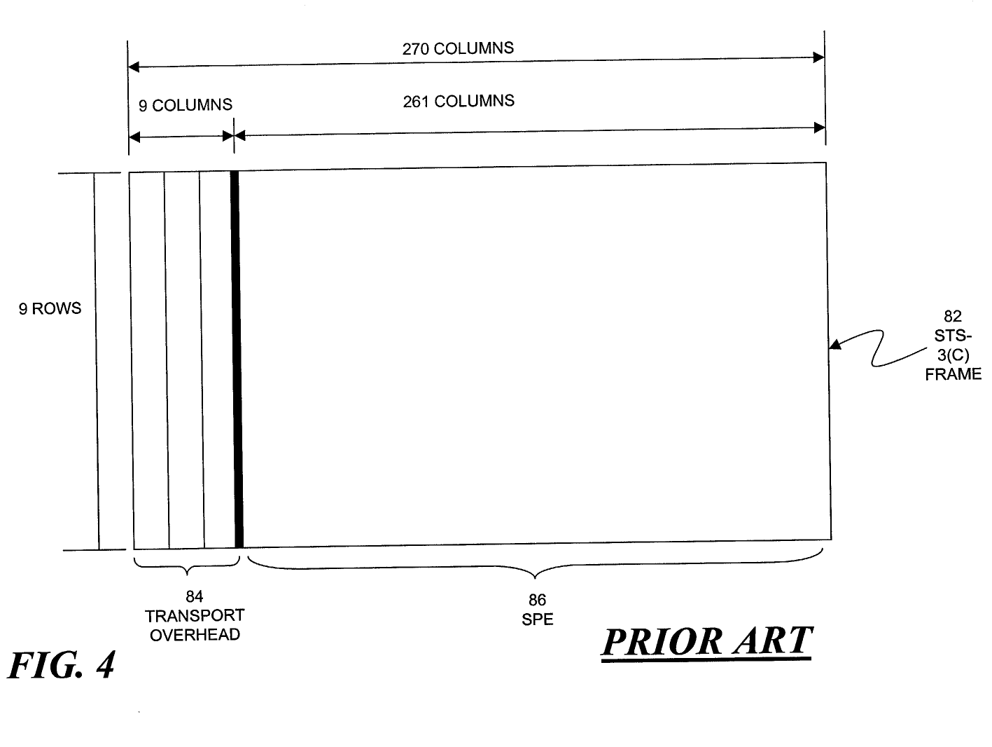

If the STS-1 does not have enough capacity, SONET offers the flexibility of concatenating multiple STS-1 Frames 50 to provide the necessary bandwidth. Concatenation can provide data rates comparable with byte-interleaved multiplexing. Referring to FIG. 4 (and FIG. 1 for reference), an STS-3(c) Frame 82 is formed by concatenating the Payloads 58 of three STS-1 Frames 50. The STS-3(c) Frame 82 can be depicted as a 270 columns by 9 rows structure. The first 9 columns represent the Transport Overhead 84, and the remaining 261 columns represent 1 column of the POH and 260 columns of the payloads, thus representing a single channel of data occupying 260 columns of the STS-3(c) SPE 86. Beyond STS-3(c), concatenation is done in multiples of STS-3(c) Frames 82.

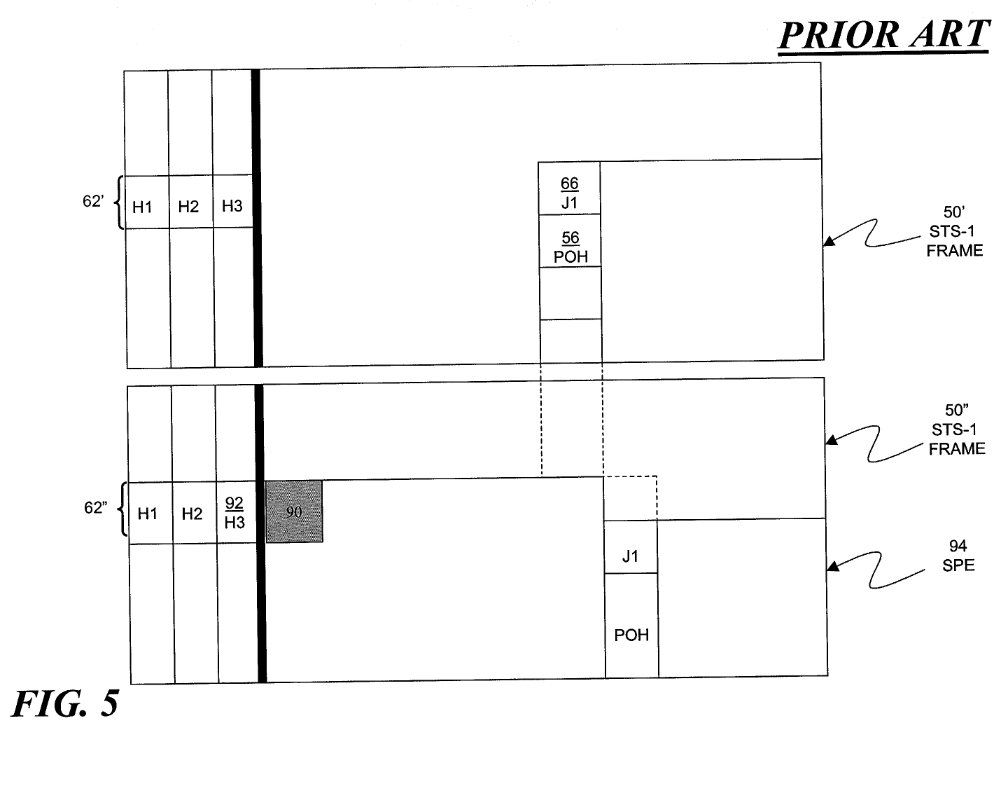

Referring back to FIGS. 1 and 2, SONET uses a concept called “byte stuffing” to adjust the value of the STS Payload Pointer 62″ preventing delays and data losses caused by frequency and phase variations between the STS-1 Frame 50′ and its SPE 54. Byte stuffing provides a simple means of dynamically and flexibly phase-aligning an STS SPE 54 to the STS-1 Frame 50′ by removing bytes from, or inserting bytes into the STS SPE 54 Referring to FIG. 5 (and FIGS. 1 and 2), as described previously, the STS Payload Pointer 62, which occupies the H1 and H2 bytes in the Transport Overhead 52 points to the first byte of the SPE 54, or the J1-byte 66, of the SPE 54. If the transmission rate of the SPE 54 is substantially slow compared to the transmission rate of the STS-1 Frame 50′, an additional Non-informative Byte 90 is stuffed into the SPE 54 section to delay the subsequent SPEs by one byte. This byte is inserted immediately following the H3 Byte 92 in the STS-1 Frame 50″. This process, known as “positive stuffing,” increases the value of the Pointer 62 by one in the next frame (for the Pointer 62″) and provides the SPE 94 with one byte delay to “slip back” in time.

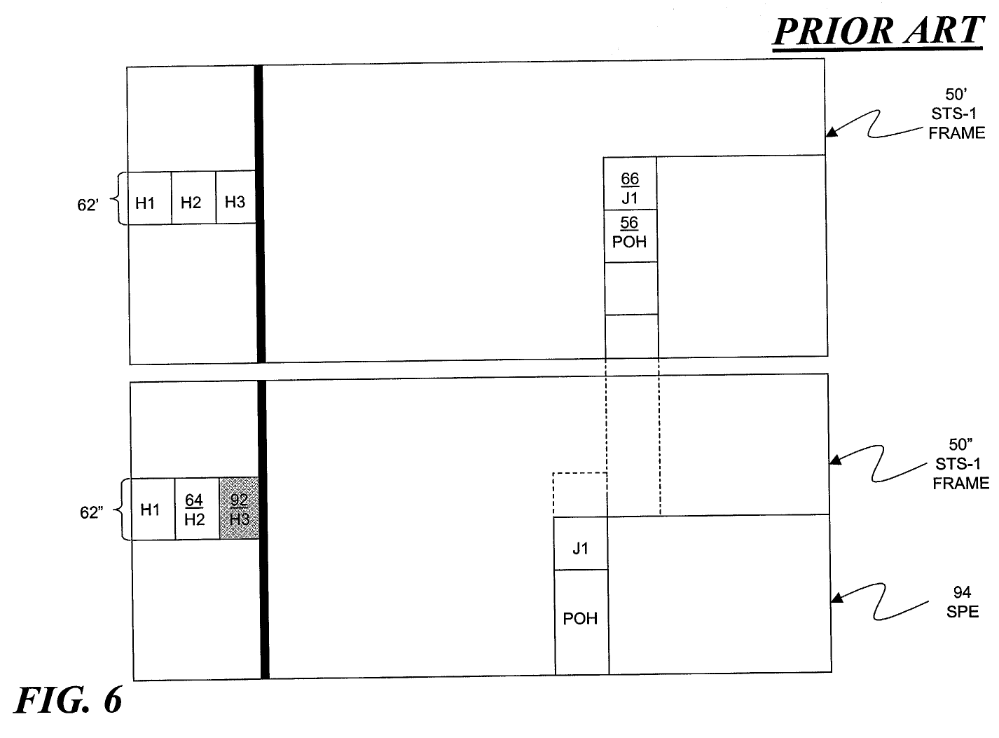

Referring now to FIG. 6, if the transmission rate of the SPE 54 is substantially fast compared to the STS-1 frame rate, one byte of data from the SPE Frame 54 may be periodically written into the H3 92 byte in the Transport Overhead of the STS-1 Frame 50″. This process, known as “negative stuffing,” decrements the value of the Pointer 62 by one in the next frame (for the Pointer 62″) and provides the subsequent SPEs, such as the SPE 94, with one byte advance.

System Overview

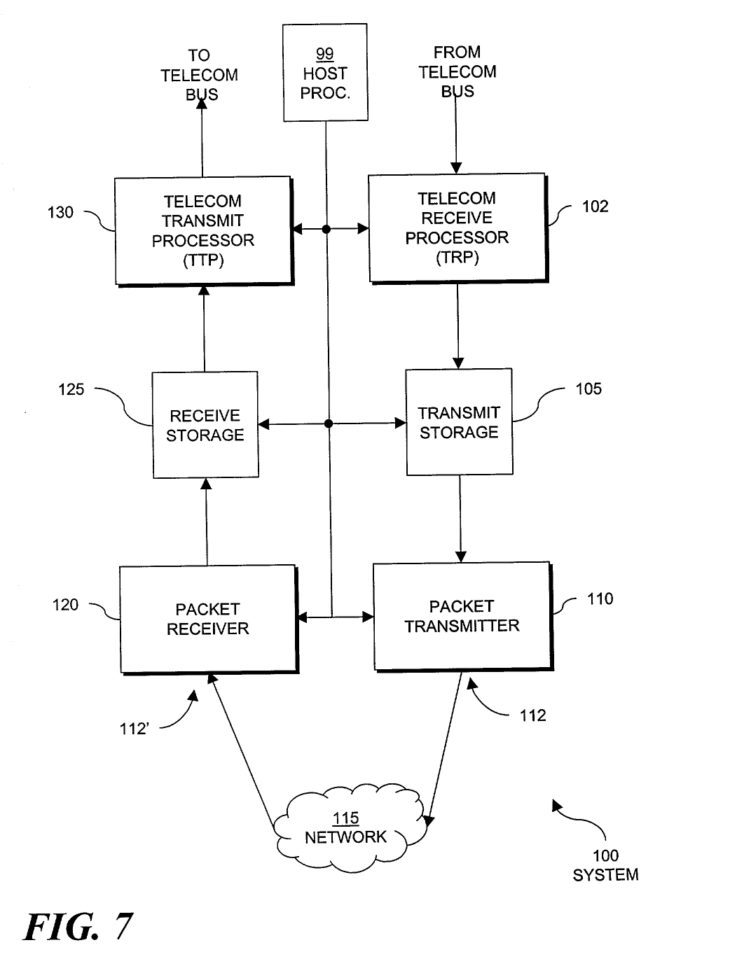

A synchronous circuit emulation over packet system transfers information content of a synchronous time-division-multiplexed (TDM) signal, such as a SONET signal, across a packet-oriented network. At a receiving end, the transferred information is used to reconstruct a synchronous TDM signal that is substantially equivalent to the original except for a transit delay. In one embodiment, referring to FIG. 7, a circuit-over-packet emulator system 100 includes a Telecommunications Receive Processor 102 (TRP) receiving a synchronous TDM signal from one or more source telecom busses. The synchronous TDM signal may be an electronic signal carrying digital information according to a predetermined protocol. The Telecom Receive Processor 102 extracts at least one channel from the information carried by the synchronous TDM signal and converts the extracted channel into at least one sequence of packets, or packet stream. Generally, each packet of the packet stream includes a header segment including information such as a source channel identifier and packet sequence number and a payload segment including the information content.

The packet payload segment of a packet may be of a fixed-size, such as a predetermined number of bytes. The packet payload generally contains the information content of the originating synchronous TDM signal. The Telecom Receive Processor 102 may temporarily store the individual packets of the packet stream in a local memory, such as a first-in-first-out (FIFO) buffer. Multiple FIFOs may be configured, one for each channel. Transmit Storage 105 receives packets from the Telecom Receive Processor 102 temporarily storing the packets. The Transmit Storage 105, in turn, may be divided into a number of discrete memories, such as buffer memories. The buffer memories may be configured allocating one to each channel, or packet stream.

A Packet Transmitter 110 receives the temporarily stored packets from Transmit Storage 105. For embodiments in which the Transmit Storage 105 includes a number of discrete memory elements (e.g., one memory element per TDM channel, or packet stream), the Packet Transmitter 110 receives one packet at a time from one of the memory elements. In other embodiments, the Packet Transmitter 110 may receive more than one packet at a time from multiple memory elements. The Packet Transmitter 110 optionally prepares the packets for transport over a packet-oriented network 115. For example, the Packet Transmitter 110 converts the format of received packets to a predetermined protocol, and forwards the converted packets to a network-interface port 112, through which the packets are delivered to the packet-oriented network 115. For example, the Packet Transmitter 110 may append an internet protocol (IP), Multiprotocol Label Switching (MPLS), and/or Asynchronous Transfer Mode (ATM) header to a packet being sent to an IP interface 112. The Packet Transmitter 110 may itself include one or more memory elements, or buffers temporarily storing packets before they are transmitted over the network 115.

Generally the packet transport header includes a label field into which the Packet Transmitter 110 writes an associated channel identifier. In some embodiments in which the label field is capable of storing information in addition to the largest channel identifier, the label field can support error detection and correction. In one embodiment, the Packet Transmitter 110 writes the same channel identifier into the label field at least twice to support error detection through comparison of the two channel identifiers, differences occurring as a result of bit errors within the label field. When the label field can accommodate at least three identical channel identifiers, a majority voting scheme can be used at the packet receiver to determine the correct channel identifier. For example, in a system with no more than 64 channels, the channel identifier consists of six bits of information. In a packet label field capable of storing 20 bits of information (e.g., an MPLS label), this six-bit field can be redundantly written three times. Upon receipt of a packet configured with a triply-redundant channel identifier in the label field, a properly-configured packet receiver compares redundant channel identifiers, declaring valid the majority channel identifier.

The one or more interfaces 112, generally adhere to physical interface standards, such as those associated with a packet-over-SONET (POS/PHY) and asynchronous transfer mode (ATM) UTOPIA. The network 115 may be a packet-switched network, such as the Internet. The packets may be routed by through the network 115 according to any of a number of network protocols, such as the transmission control protocol/internet protocol (TCP/IP), or MPLS.

In the other direction, a Packet Receiver 120 receives from the network 115 packets of a similarly generated packet stream. The Packet Receiver 120 includes a network-interface port 112′ configured to an appropriate physical interface standard (e.g., POS/PHY, UTOPIA). The Packet Receiver 120 extracts and interprets the packet information (e.g., the packet header and the packet payload), and transmits the extracted information to Receive Storage 125. As discussed above, the Packet Receiver 120 can be configured to include error detection, or majority-voting functionality for comparing multiply-redundant channel identifiers to detect and, in the case of majority voting, correct bit errors within the packet label. In one embodiment, the voting functionality includes comparitors comparing the label bits corresponding to equivalent bits of each of the redundant channel identifiers.

The Receive Storage 125 may include a memory controller coordinating packet storage within the Receive Storage 125. A Telecom Transmit Processor (TTP) 130 reads stored packet information from the Receive Storage 125, removes packet payload information, and recombines the payload information forming a delayed version of the originating synchronous transport signal. The Telecom Transmit Processor 130 may include signal conditioning similar to that described for the Telecom Receive Processor 102 for ensuring that the reconstructed signal is in a format acceptable for transfer to the telecom bus. The Telecom Transmit Processor 130 then forwards the reconstructed signal to the telecom bus.

In one embodiment, the system 100 is capable of operating in at least two operational modes: independent configuration mode and combined configuration mode. In the independent configuration mode, the telecom busses operate independently with respect to each other, whereas in combined configuration mode, multiple telecom busses operate in cooperation with each other providing portions of same signal. For example, a system 100 may receive input signals, such as SONET signals, from four telecom buses (e.g., each bus providing one STS-12, referred to as “quad STS-12 mode”). In independent configuration mode, the system 100 operates as if the four received STS-12 signals are unrelated and they are processed independently. For the same example in combined configuration mode, the system 100 operates as if the four received STS-12 signals each represent one-quarter of a single STS-48 signal (“single STS-48 mode”). When operating in quad STS-12 mode, the four source telecom buses are treated independently allowing the signal framing to operate independently with respect to each bus. Accordingly, each telecom bus provides its own timing signals, such as a clock and SONET frame reference (SFP), and its own corresponding frame overhead signals, such as SONET H1 and H2 bytes, etc.

Alternatively, when operating in single STS-48 mode, the four source telecom buses are treated as being transport-frame aligned. That is, the four busses may be processed according to the timing signals of one of the busses. A user may select which of the four interconnected buses should serve as the reference bus for timing purposes. The SONET frame reference and corresponding overhead signals are then derived from the reference bus and applied to signals received from the other source telecom buses. Regardless of configuration mode, each source telecom bus can be disabled by the Telecom Receive Processor 102. When a telecom bus is disabled, the incoming data on that telecom bus is forced to a predetermined state, such as a logical zero.

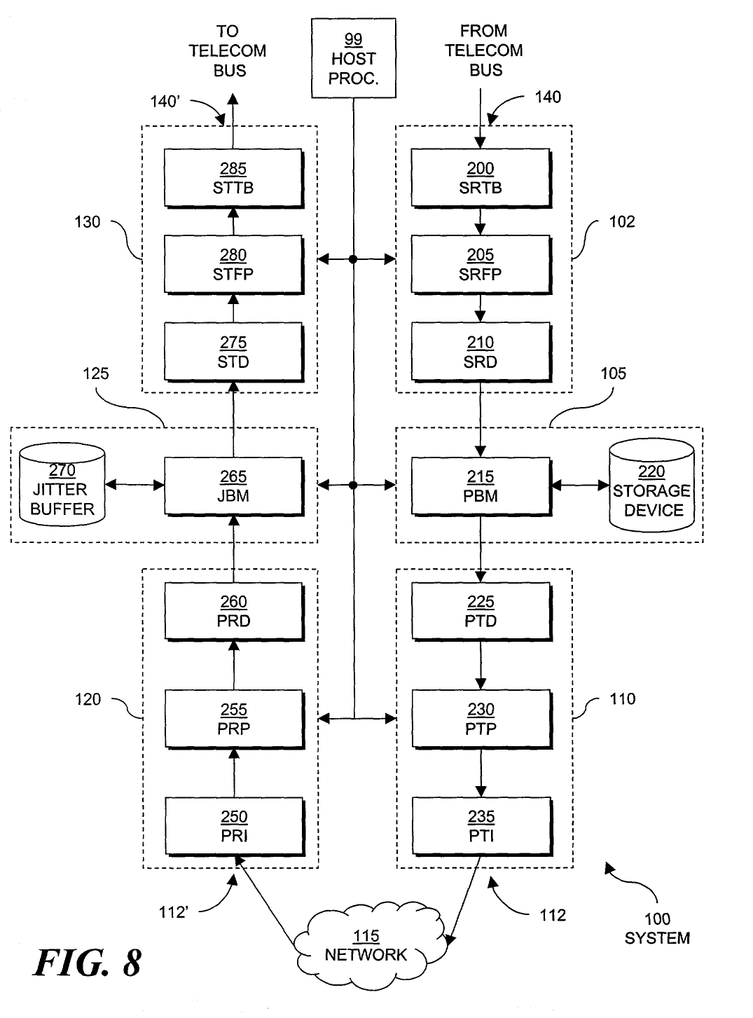

In more detail, referring to FIG. 8, the Telecom Receive Processor 102 includes a Synchronous Receive Telecom Bus interface (SRTB) 200 having one or more interface ports 140 in communication with one or more telecom busses, respectively. Each of the interface ports 140 receives telecom signal data streams, such as synchronous TDM signals, and timing signals from the respective telecom bus. In general, the Synchronous Receive Telecom Bus Interface 200 receives signals from the telecom bus, and performs parity checking and preliminary signal conditioning such as byte reordering, on the received signals. The Synchronous Receive Telecom Bus Interface 200 also generates signals, such as timing reference and status signals and distributes the generated signals to other system components including the interconnected telecom bus.

The Synchronous Receive Frame Processor 205 receives the conditioned signals from the Synchronous Receive Telecom Bus Interface 200 and separates the data of received signals into separate channels, as required. The Synchronous Receive Frame Processor 205 then processes each channel of information, creating at least one packet stream for each processed channel. The Synchronous Receive Frame Processor 205 temporarily stores, or buffers, for each channel the received signal information. The Synchronous Receive Frame Processor 205 assembles a packet for each channel. In one embodiment, the payload of each packet contains a uniform, predetermined amount of information, such as a fixed number of bytes. When less than the predetermined number of bytes is received, the Synchronous Receive Frame Processor 205 may nevertheless create a packet by providing additional place-holder information (i.e., not including informational content). For example, the SRFP 205 may add binary zeros to fill byte locations for which received data is not available. The Synchronous Receive Frame Processor 205 also generates a packet header. The packet header may include information, such as, a channel identifier identifying the channel, and a packet-sequence number identifying the ordering of the packets within the packet stream.

A Synchronous Receive DMA engine (SRD) 210 reads the generated packet payloads and packet headers from the individual channels of the SRFP 205 and writes the information into Transmit Storage 105. In one embodiment, the SRD 210 stores packet payloads and packet headers separately.

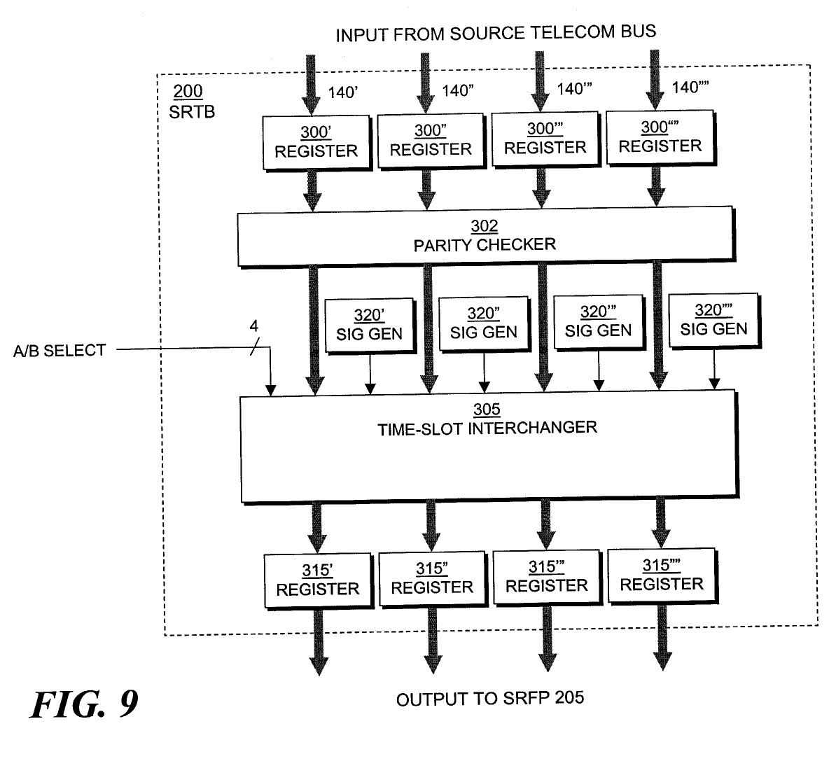

In one embodiment, referring now to FIG. 9, the SRTB 200 receives, during normal operation, synchronous TDM signals from up to four telecommunications busses. The SRTB 200 also performs additional functions, such as error checking and signal conditioning. In more detail, some of the functions of the Synchronous Receive Telecom Bus Interface 200 include providing a J0REF signal to the incoming telecommunications bus; performing parity checks on incoming data and control signals; and interchanging timeslots or bytes of incoming synchronous TDM signals. The Synchronous Receive Telecom Bus Interface 200 also constructs signals for further processing by the Synchronous Receive Frame Processor 205 (SRFP), passes payload data to the Synchronous Receive Frame Processor 205, and optionally accepts data from the telecom busses for time-slot-interchange SONET transmit-loopback operation.

The Synchronous Receive Telecom Bus Interface 200 includes at least one register 300′, 300″, 300′″, 300″″ (generally 300) for each of the telecom bus interface ports 140′, 140″, 140′″, 140″″ (generally 140). Each of the registers 300 receives and temporarily stores data from the interconnected telecom bus. The Synchronous Receive Telecom Bus Interface 200 also includes a Parity Checker 302 monitoring each telecom signal data stream, including a parity bit, from the registers 300 and detecting the occurrence of parity errors within the received data. The Parity Checker 302 transmits a parity error notification in response to detecting a parity error in the monitored data. In an independent configuration mode, each telecom bus generally has its own parity options from which to check the parity. The independent parity options may be stored locally within the Synchronous Receive Telecom Bus Interface 200, for example in a configuration register (not shown). In a combined configuration mode, the parity checker 302 checks parity according to the parity options for data received from one of the telecom busses, applying the parity options to data received from all of the telecom busses.

The register 300 is in further electrical communication, through the parity checker 302, with a Time Slot Interchanger 305 (TSI). In one embodiment, the TSI 305 receives data independently from each of the four registers 300. The TSI 305 receives updated telecom bus signal data from the registers 300 with each clock cycle of the bus. The received sequence of bytes may be more generally referred to as timeslots—the data received from one or more of the telecom busses at each clock cycle of the bus. A timeslot represents the data on the telecom bus during a single clock cycle of the bus (e.g., one byte for a telecom bus consists of a single byte lane, four bytes for four telecom busses, each containing a single byte lane). The TSI 305 may optionally reorder the timeslots of the received signal data according to a predetermined order. Generally, the timeslot order repeats according to the number of channels being received within the received TDM signal data. For example, the order would repeat every twelve cycles for a telecom bus carrying an STS-12 signal. The TSI 305 may be configured to store multiple selectable timeslot ordering information. For example, the TSI 305 may include an “A” order and a “B” order for each of the received data streams. The TSI 305 receives a user input signal (e.g., “A/B SELECT”) to select and control which preferred ordering is applied to each of the processed data streams.

In one embodiment, the TSI 305 is in further electrical communication with a second group of registers 315′, 315″, 315′″, 315″″ (generally 315), one register 315 for each telecom bus. The TSI 305 transmits the timeslot-reordered signal data to the second register 315 where the data is temporarily stored in anticipation of for further processing by the system 100.

In one embodiment, the Synchronous Receive Telecom Bus Interface 200 includes at least one signal generator 320′, 320″, 320′″, 320″″ (generally 320) for each received telecom signal data stream. The signal generator 320 receives at least some of the source telecom bus signals (e.g., J0J1FP) from the input-register 300 and generate signals, such as timing signals (e.g., SFP). In one embodiment, the signal generator 320 generates from the SFP signal a modulo-N counter signal, such as a mod-12 counter for a system 100 receiving STS-12 signals. When operating in a combined mode, the modulo-N counter signals may be synchronized with respect to each other.

The Synchronous Receive Telecom Bus Interface 200 is capable of operating in structured or unstructured operational mode. In an unstructured operational mode, the Synchronous Receive Telecom Bus Interface 200 expects to receive valid data from the telecom bus including data and clock. In general, all data can be captured in unstructured operational mode. In an unstructured mode, the signal generators 320 transmit predetermined signal values for signals that may be derived from the telecom bus in structured mode operation. For example, in unstructured mode, the signal generator 320 may generate and transmit a payload active signal and a SPE_Active signal causing suppression in the generation of overhead signals, such as the H1, H2, H3, and PSO signals. This presumption of unstructured operational mode combined with the suppression of overhead signals allows the Synchronous Receive Frame Processor 205 to capture substantially all data bytes for each of the telecom buses. Operating in an unstructured operational mode further avoids any need for interchanging time slots, thereby allowing operation of the TSI 305 in a bypass mode for any or all of the received telecom bus signals.

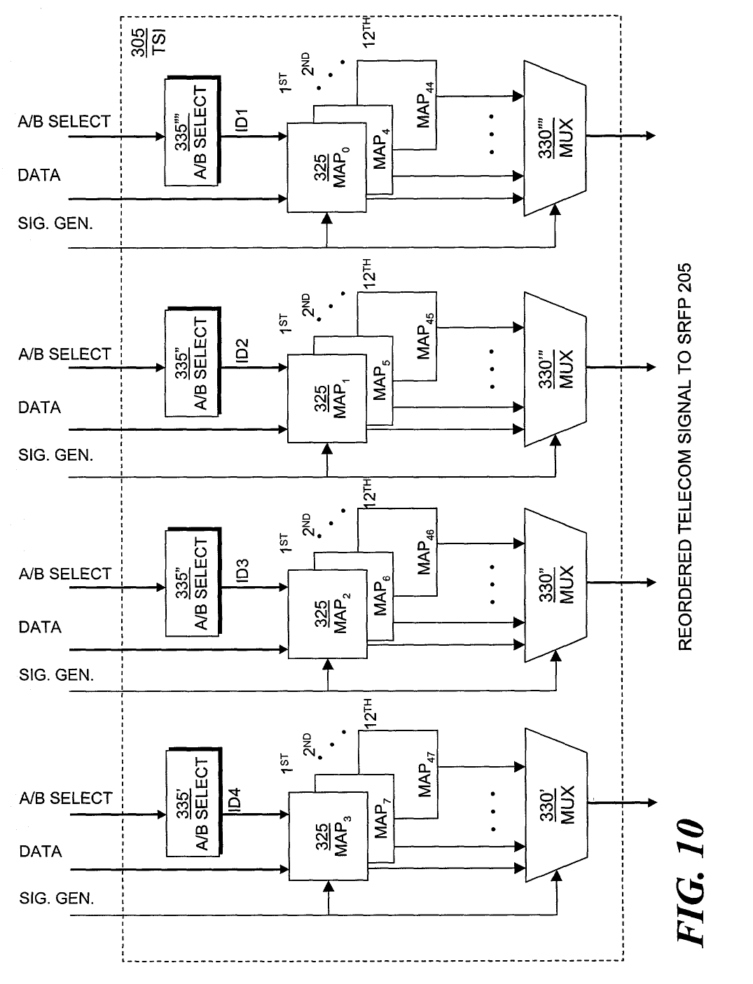

Referring to FIG. 10, the TSI 305 receives telecom signal data streams and assigns the received data to timeslots in the order in which the data is received. The order of an input sequence of timeslots referred to as TSIN, generally repeats according to a predetermined value, such as the number of channels of data received. The TSI 305 re-maps the TSIN to a predetermined outgoing timeslot order referred to as TSOUT. Thus, the TSI 305 reorders timeslots according to a relationship between TSIN and TSOUT. In one embodiment, the TSI 305 includes a number of user pre-configurable maps 325, for example, one map 325 for each channel of data (e.g., map₀ 325 through map₄₇ 325 for 48 channels of data). The maps 325 store a relationship between TSIN to TSOUT. The map 325 may be implemented in a memory element containing a predetermined number of storage locations, the location corresponding to the TSOUT order, in which each TSOUT location stores a corresponding TSIN reference value. Table 1 below shows one embodiment of the TSOUT reference for a quad STS-12, or single STS-48 telecom bus.

Each of the maps 325 transmits an output timeslot to a multiplexer (MUX) 330′, 330″, 330′″, 330″″ (generally 330). The MUX 330, in turn, receives an input from the Signal Generator 320 corresponding to the current timeslot. The MUX 330 selects one of the inputs received from the maps 325 according to the received signal and transmits the selected signal to the Synchronous Receive Frame Processor 205. In the illustrative embodiment, the TSI 305 includes four MUXs 330, one MUX 330 for each received telecom bus signal. The TSI 305 also includes forty-eight maps 325, configured as four groups of twelve maps 325, each group interconnected to a respective MUX 330.

TABLE 1
TSI Position Reference Numbering

| | 1^{st} | 2^{nd} | 3^{rd} | 4^{th} | 5^{th} | 6^{th} | 7^{th} | 8^{th} | 9^{th} | 10^{th} | 11^{th} | 12^{th} |
|---|---|---|---|---|---|---|---|---|---|---|---|---|
| ID1 | 0 | 4 | 8 | 12 | 16 | 20 | 24 | 28 | 32 | 36 | 40 | 44 |
| [7..0] | | | | | | | | | | | | |
| ID2 | 1 | 5 | 9 | 13 | 17 | 21 | 25 | 29 | 33 | 37 | 41 | 45 |
| [7..0] | | | | | | | | | | | | |
| ID3 | 2 | 6 | 10 | 14 | 18 | 22 | 26 | 30 | 34 | 38 | 42 | 46 |
| [7..0] | | | | | | | | | | | | |
| ID4 | 3 | 7 | 11 | 15 | 19 | 23 | 27 | 31 | 35 | 39 | 43 | 47 |
| [7..0] | | | | | | | | | | | | |

The numbers in Table 1 refer to the incoming timeslot position, and do not necessarily represent the incoming byte order. In the exemplary configuration, the system 100 processes information from the source telecom buses 32 bits at a time, taking one byte from each source telecom bus. In single STS-48 mode where the incoming buses are frame aligned, the first 32 bits (i.e., bytes) processed will be TSIN positions 0, 1, 2, and 3, (column labeled “1^{st}” in Table 1) followed by bytes in positions 4, 5, 6, 7 column labeled “2^{nd}” in Table 1) in the next clock cycle, etc. In quad STS-12 mode where the incoming buses are not necessarily aligned, the first 32 bits could be any TSIN positions such as, 4, 9, 2 and 3, followed by 8, 13, 6, 7 in the next clock cycle, etc.

In one embodiment, the TSI 305 may be dynamically configured to allow a user-reconfiguration of a preferred timeslot mapping during operation, without interrupting the processing of received telecom bus signals. For example, the TSI 305 may be configured with redundant timeslot maps 325 (e.g., A and B maps 325). At any given time, one of the two maps 325 is selected according to the received A/B SELECT signal. The unselected map may be updated with a new TSIN-TSOUT relationship and later applied to the processing of received telecom signal data streams by selecting the updated map 325 through the A/B SELECT signal. Such a redundant configuration each map 325 includes two similar maps 325 controlled by a A/B Selector 335, or switch.

The A/B Selector 335 may include an electronic latch, a transistor switch, or a mechanical switch. In some embodiments the A/B selector 335 also receives a timing signal, such as the SFP to control the timing of a reselection of maps 325. For example, the A/B selector 335 may receive at a first time an A/B Select control signal to switch, but refrain from implementing the switchover until receipt of the SFP signal. Such a configuration allows a selected change of the active timeslot maps 325 to occur on a synchronous frame boundary. Re-mapping within the map groupings associated with a single received telecom bus signal may be allowed at any time, whereas mapping among the different map groupings corresponding to mapping among multiple received telecom bus signals is generally allowed when the buses are frame aligned.

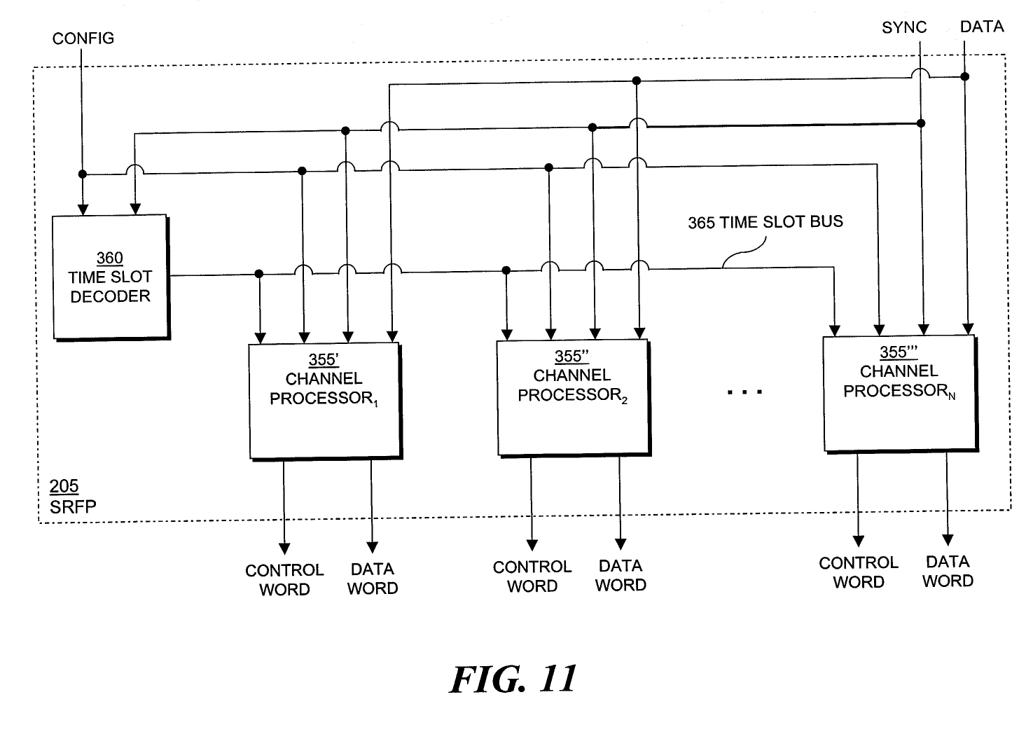

Referring to FIG. 11, the Synchronous Receive Frame Processor 205 receives one or more data streams from the Synchronous Receive Telecom Bus Interface 200. For applications in which a timeslot re-mapping is not required, however, the Synchronous Receive Frame Processor 205 may receive data directly from the one or more telecom busses, thereby eliminating, or bypassing the Synchronous Receive Telecom Bus Interface 200. The Synchronous Receive Frame Processor 205 also includes a number of receive channel processors: Channel Processor₁ 355′ through Channel Processor_{N} 355′″ (generally 355). Each receive Channel Processor 355 receives data signals and synchronization (SYNC) signals from the data source (e.g., from the Synchronous Receive Telecom Bus Interface 200 or directly from the source telecom bus). In one embodiment, each of receive Channel Processors 355 receives input from all of the source telecom buses. The Synchronous Receive Frame Processor 205 also includes a Time Slot Decoder 360 receiving configuration information and the SYNC signal and transmitting a signal to each of the receive Channel Processors 355 via a Time Slot Bus 365.

The Synchronous Receive Frame Processor 205 sorts received telecom data into output channels, at least one receive Channel Processor 355 per received channel. The receive Channel Processors 355 process the received data, create packets, and then transmit the packets to the SRD 210 in the form of data words and control words. The Time Slot Decoder 360 associates received data (e.g., a byte) with a time slot to which the data belongs. The Time Slot Decoder 360 transmits a signal to each of the receive Channel Processors 355 identifying one or more Channel Processors 355 for each timeslot. The Channel Processors 355 reads the received data from the data bus responsive to reading the channel identifier from the Time Slot Bus 365.

The receive Channel Processors 355 may be configured in channel clusters representing a logical grouping of several of the receive Channel Processors 355. For example, in one embodiment, the Synchronous Receive Frame Processor 205 includes forty-eight receive Channel Processors 355 configured into four groups, or channel clusters, each containing twelve receive Channel Processors 355. In this configuration, the data buses are configured as four busses, and the Time Slot Bus 365 is also configured as four busses. In this manner, each of the receive Channel Processors 355 is capable of receiving signal information from a channel occurring within any of the source telecom busses.

The receive Channel Processor 355 intercepts substantially all of the signal information arriving for a given channel (e.g., SONET channel), and then processes the intercepted information to create a packet stream for each channel. Within the context of the receive Channel Processor 355, a SONET channel refers to any single STS-1/STS-N(c) signal. By convention, channels are formed using STS-1, STS-3(c), STS-12(c) or STS-48(c) structures. The receive Channel Processor 355, however, is not limited to these choices. For example, the system 100 can accommodate a proprietary channel bandwidth and processes, if so warranted by the target application, by allowing a combination of STS-N timeslots to be concatenated into a single channel.

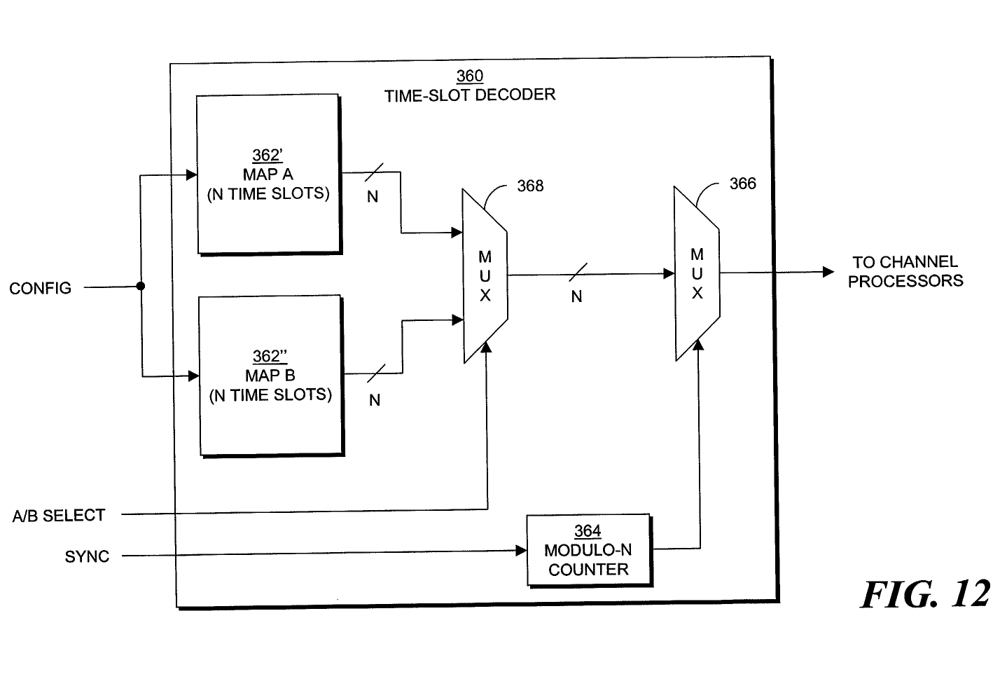

Referring now to FIG. 12, the Time Slot Decoder 360 includes a user-configured Time Slot Map 362′. The Time Slot Map 362′ generally includes “N” storage locations, one storage location for each channel. The Time Slot Decoder 360 reads from the Time Slot Map 362′ at a rate controlled by the SYNC signal and substantially coincident with the data rate of the received data. The Time Slot Map 362′ stores a channel identifier in each storage location. Thus, for each time slot, the Time Slot Decoder 360 broadcasts at least one channel identifier on the Time Slot Bus 365 to the interconnected receive Channel Processors 355. The Time Slot Decoder 360 includes a modulo-N counter 364 receiving the SYNC signal and transmitting a modulo-N output signal. The Time Slot Decoder 360 also includes a Channel Select Multiplexer (MUX) 366 receiving an input from each of the storage locations of the Time Slot Map 362′. The MUX 366 also receives the output signal from the Modulo-N Counter 364 and selects one of the received storage locations in response to the received counter signal. In this manner, the MUX 366 sequentially selects each of the N storage locations, thereby broadcasting the contents of the storage location (the channel identifiers) to the receive Channel Processors 355. The Time Slot Maps 362 may be configured with multiple storage locations including the same channel identifier for a single time slot. Configured, multiple receive Channel Processors will process the same channel of information resulting in multicast. Multicast operation may be advantageous in improving reliability of critical data, or writing common information to multiple channels.

In one embodiment, the Time Slot Decoder 360 includes a similarly configured second, or shadow, Time Slot Map 362″ storing an alternative selection of channel identifiers. One of the Time Slot Maps 362′, 362″ (generally 362) is operative at any given moment, while the other Time Slot Map 362 remains in a standby mode. Selection of a desired Time Slot Map 362 may be accomplished with a time slot map selector. In one embodiment the time slot map selector is an A/B Selection Multiplexer (MUX) 368, as shown. The MUX 368 receives the output signals from each of the Time Slot Maps 362. The MUX 368 also receives an A/B SELECT signal controlling the MUX 368 to forward signals from only one of the Time Slot Maps 362. The time slot selector may also be configured through the use of additional logic such that a user selection to change the Time Slot Map 362 is implemented coincident with a frame boundary.

Either of the Time Slot Maps 362 when in standby mode may be reconfigured storing new channel identifiers in each storage entry without impacting normal operation of the Time Slot Decoder 360. The second Time Slot Map 362 allows a user to make configuration changes to be made over multiple clock cycles and then apply the new configuration concurrently. Advantageously, this capability allows reconfiguration of the channel processor assignments, as directed by the Time Slot Map 362 without interruption to the processed data stream. This shadow reconfiguration capability also insures that unintentional configurations are not erroneously processed during a map reconfiguration process.

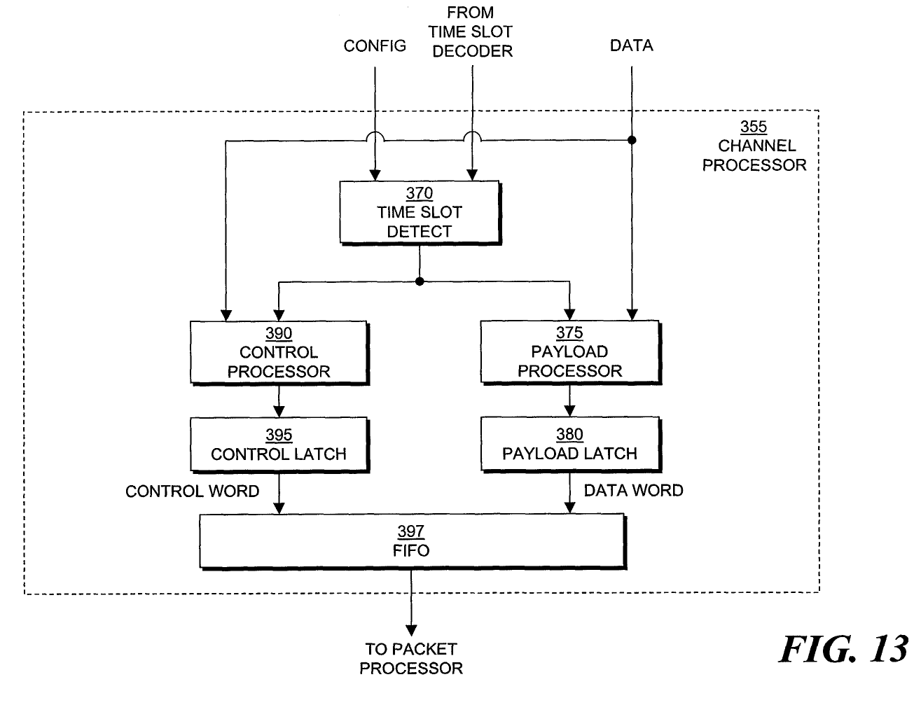

Referring to FIG. 13, the receive Channel Processor 355 includes a Time Slot Detector 370 receiving time slot signals from the Time Slot Bus 365. The Time Slot Detector 370 also receives configuration data and transmits an output signal when the received time slot signal matches a pre-configured channel identifier associated with the receive Channel Processor 355. The receive Channel Processor 355 also includes a Payload Processor 375 and a Control Processor 390, each receiving telecom data and each also receiving the output signal from the Time Slot Detector 370. The Payload Processor 375 and the Control Processor 390 read the data in response to receiving the time slot detector output signal. The Payload Processor 375 writes payload data to a Payload Latch 380 that temporarily stores the payload data. The Payload Latch 380 serves as a staging area for assembling a long-word data by storing the data as it is received until a complete long-word data is stored within the Payload Latch 380. Completed long-words are then transferred from the Payload Latch 380 to the Channel FIFO 397.

Similarly, the Control Processor 390 writes overhead data to a Control Latch 395 that temporarily stores the overhead data. The Control Latch 395 serves as a staging area for assembling packet overhead information related to the packet data being written to the Channel FIFO 397. Any related overhead data is written into the Control Latch 395 as it is received until a complete packet payload has been written to the Channel FIFO 397. The Control Processor 390 then clocks the packet overhead information from the Control Latch 395 into a Channel Processor FIFO 397. The Channel FIFO 397 temporarily stores the channel packet data awaiting transport to the transmit storage 105.

In one embodiment, the Control Processor 390 latches data bytes containing the SPE payload pointer (e.g., H1, and H2 overhead bytes of a SONET application). The Control Processor 390 also monitors the SPE Pointer for positive or negative pointer justifications. The Control Processor 390 encodes any detected pointer justifications and places them into the channel-processor FIFO 397 along with any J1 byte indications.

SRD

In one embodiment, a synchronous receive DMA engine (SRD) 210 reads packet data from the channel processor FIFO 397 and writes the data received to the transmit storage 105. The SRD 210 may also take packet overhead information from the Channel FIFO 397 and create a CEM/TDM header, as described in, for example, SONET/Synchronous Digital Hierarchy (SDH) Circuit Emulation Over MPLS (CEM) Encapsulation to be written the Transmit Storage 105 along with the packet data. The transmit storage 105 may include a single memory. Alternatively, the transmit storage 105 may include separate memory elements for each channel. In either instance, buffers for each channel are configured to store the packet data from the respective channel processors 355. A user may thus configure the beginning and ending addresses of each channel's buffer by storing the configuration details in one or more registers. The SRD 210 uses the writing pointer to write eight bytes to the buffer in response to a phase clock being a logical “high.” For subsequent writes to the buffer, the DMA engine may first compare the buffer writing pointer and the buffer reading pointer to ensure that they are not the same. When the buffer writing pointer and the buffer reading pointer are the same value, it indicates that the buffer is full, and a counter should be incremented.

Transmit Storage

Referring again to FIG. 7, in one embodiment, the Transmit Storage 105 acts as the interface between the Telecom Receive Processor 102 and the Packet Transmitter 110 temporarily storing packet streams in their transit from the Telecom Receive Processor 102 to the Packet Transmitter 110. The Transmit Storage 105 includes a Packet Buffer Manager (PBM) 215 that is coupled to the FIFO (first-in-first-out) Storage Device 220. The Packet Buffer Manager 215 organizes packet payloads and their corresponding packet header information, such as the CEM/TDM header that contains overhead and pointer adjustment information, and places them in the Storage Device 220. The Packet Buffer Manager 215 also monitors the inflow and outflow of the packets from the Storage Device 220 and controls such flows to prevent overflow of the Storage Device 220. As some channels may have a greater bandwidth than others, stored packets associated with those channels will necessarily be read from memory at a faster rate than channels having a lower bandwidth. For example, a packet stream associated with a channel processing an STS-3(c) signal will fill the Storage Device 220 approximately three times faster than a packet stream associated with an STS-1. Accordingly, the STS-3(c) packets should be read from the Storage Device 220 at a greater rate than STS-1 packets to avoid memory overflow.

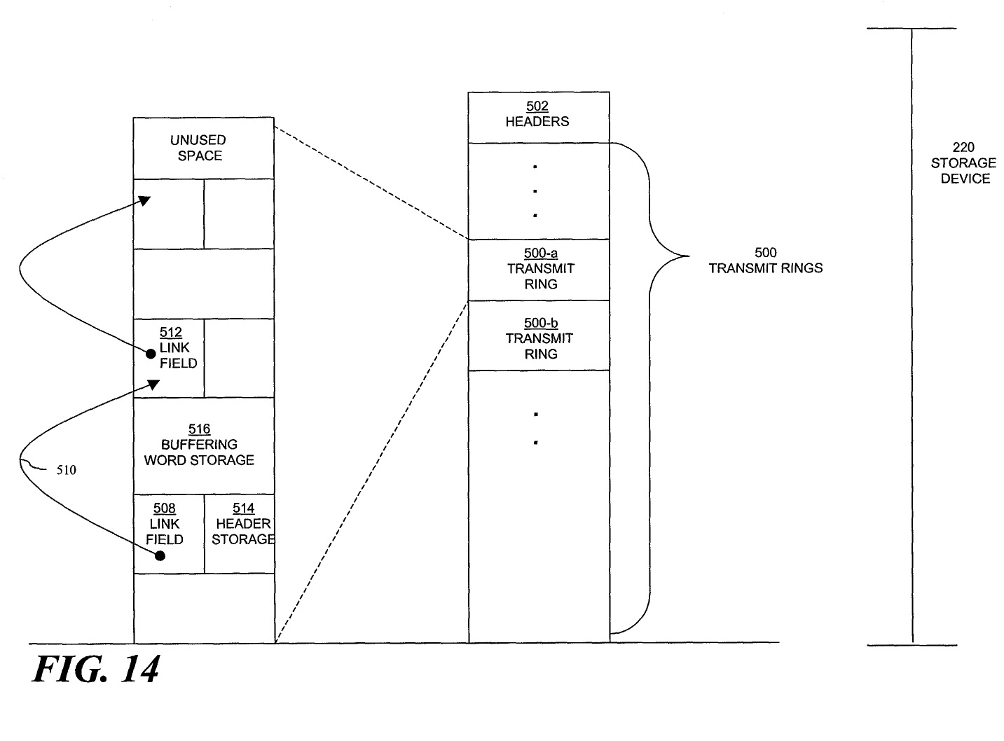

Referring to FIG. 14, in one embodiment, the Storage Device 220 comprises a number of buffer memories that include several Transmit Rings 500 and a Headers Section 502. In one particular embodiment, the Storage Device 220 comprises the same number of Transmit Rings 500 as the number of channels. The Storage Device 220 stores one packet's worth of data for current operation by the Packet Transmitter 110 in addition to at least one packet's worth of data for future operation by the Packet Transmitter 110. Each of the Transmit Rings 500 (for example the Transmit Ring 500-a), preferably ring buffers, comprises a Link Fields 508, each having a Next Link Field Pointer 510 that points to the next Link Field 512, one or more Header Storage 514 to store information to build or track the packet header, and one or more Buffering Word Storage 516. Both the SRD 210 and the Packet Transmit Processor (PTP) 230 use the Transmit Rings 500 such that the SRD 210 fills the Transmit Rings 500 with data while the PTP 230 drains the data from the Transmit Rings 500. As discussed above, each of the Transmit Rings 500 allocates enough space to contain at least two full CEM packet payloads, one packet payload for current use by a Packet Transmit Processor 230 (PTP) and additional payloads are placed in each of the Buffering Word Storage 516 for future use by the PTP 230.

In one particular embodiment, in order to accommodate faster channels having greater bandwidths than others, additional Buffering Word Storage 516 space can be provided to store more data by linking multiple Transmit Rings 500 together. For example, the Transmit Rings 500 can be linked by having the pointer in the last link field of the Transmit Ring 500-a to point to the first link field of the next Transmit Ring 500-b and having the pointer in the last link field of the next Transmit Ring 500-b to point to the first link field of the Transmit Ring 500-a.

Referring still to FIG. 14, the Headers Section 502, which represents each of the channels, is placed before the Transmit Rings 500. Because the Headers Section 502 is not interpreted by the system 100, the Headers Section can be a configurable number of bytes of information provided by a user to prepare data for transmission across the Network 115. For example, the Headers Section 502 can include any user-defined header information programmable for each channel, such as IP stacks or MPLS (Multi-protocol Label Switching) labels.

Referring again to FIG. 8, the Packet Transmitter 110 retrieves the packets from the Packet Buffer Manager 215 and prepares these packets for transmission across the Packet-Oriented Network 115. In one embodiment, such functions of the Packet Transmitter 110 are provided by a Packet Transmit DMA Engine 225 (PTD), the Packet Transmit Processor 230 (PTP), and a Packet Transmit Interface 235 (PTI).

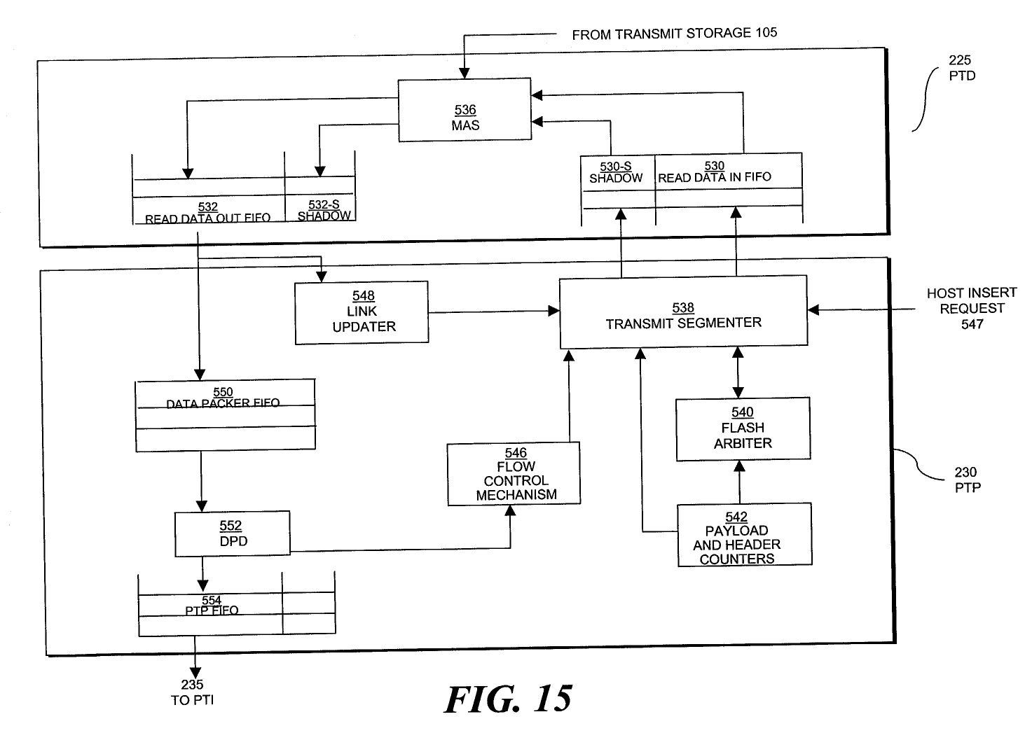

Referring to FIG. 15, the PTD 225 receives the address of requested packets segments from the PTP 230 and returns these packet segments to the PTP 230 as requested by the PTP 230. The PTP 230 determines the address of the data to be read and requests the PTD 225 to fetch the corresponding data. In one embodiment, the PTD 225 comprises a pair of FIFO buffers, in which a Input FIFO 530 stores the addresses of the data requested by the PTP 230 and a Output FIFO 532 provides these data to the PTP 230, their respective Shadow FIFOs, 530-S and 532-S, and a Memory Access Sequencer 536 (MAS) in electrical communication with both of the FIFOs 530 and 532. In one particular embodiment, the Input FIFO 530 stores the addresses of the requested packet segments generated by a Transmit Segmenter 538 of the PTP 230. As the entries are written into the Input FIFO 530, control words for these entries, such as Packet Start, Packet End, Segment Start, Segment End, CEM Header, and CEM Channel, that indicate the characteristics of the entries are written into the correlated Shadow FIFO 530-S by the Transmit Segmenter 538 of the PTP 230 as well. The Memory Access Sequencer 536 assists the PTD 225 to fulfill PTP's requests by fetching the requested data from the Storage Device 220 and delivering the data to the Output FIFO 532.

Referring again to FIG. 15, in one embodiment, the PTP 230 receives data from the Storage Device 220 via PTD 225, the PTP 230 processes these data and releases the processed data to the PTI 235. In more detail, the PTP 230 includes the Transmit Segmenter 538 that determines which packet segments should be retrieved from the Storage Device 220. The Transmit Segmenter 538 is in electrical communication with a Flash Arbiter 540, a Payload and Header Counters 542, a Flow Control Mechanism 546, a Host Insert Request 547, and a Link Updater 548 to process the packet segments before transferring them to the PTI 235. A Data Packer FIFO 550, coupled to the Link Updater 548, temporarily stores the retrieved packet segments from the Output FIFO 532 for a Dynamic Data Packer 552. The Dynamic Data Packer 552, as the interface between the Data Packer FIFO 550 and the PTP FIFO 554, prepares these packet segments for the PTI 235. In one particular implementation, the PTP 230 takes packet segments from the PTD 225 along with control information from Shadow FIFO 532-S and processes these packet segments by applicably pre-pending the CEM/TDM header, as described in, for example, SONET/SDH Circuit Emulation Over MPLS (CEM) Encapsulation, in addition to pre-pending user-supplied encapsulations, such as MPLS labels, ATM headers, and IP headers, to each packet.

Furthermore, the PTP 230 delivers the processed packets (or cells for ATM network) to the PTI 235 in a fair manner that is based on the transmission rate of each channel. In a particular embodiment, the fairness involves delivering forty-eight bytes of packet segments to the pre-selected External Interfaces, for example the UTOPIA or the POS/PHY, of the PTI 235, in a manner that resembles the delivery using the composite bandwidth of the channels. In one particular embodiment, because the packet segments cannot be interleaved on a per channel basis to utilize the composite bandwidth of the channels, a fast channel that is ready for transmission becomes the first channel to push out its packet. The Flash Arbiter 540 carries out this function by selecting such channels for transmission.

Referring again to FIG. 15, the Flash Arbiter 540 receives payload and header count information from the Payload and Header Counters 542 (CPC 542-a and CHC 542-b, respectively), arbitrates based on these information, and transmits its decision to the Transmit Segmenter 538. The Flash Arbiter 540 comprises a large combinatorial circuit that identifies the channel with the largest quanta of information, or the most number of bytes queued for transmissions, and selects such channel for transmission. The Flash Arbiter 540 then generates a corresponding identifier or signal for the selected channel, such as Channel 1-Ready, . . . , Channel 48-Ready. When a channel is selected for transmission, the channel delivers its entire packet to be transmitted over the network.

The CPC 542-a and the CHC 542-b control the flow of data between the SRD 210 and the PTP 230. The SRD 210 increments the CPC 542-a whenever a word of payload is written into the Storage Device 220. The PTP 230 decrements the CPC 542-a whenever it reads a word of payload from the Storage Device 220, thus the CPC 542-a ensures that at least one complete packet is available for transmission over the Network 115. The SRD 210 decrements the CHC 542-b whenever a CEM packet is completed and its respective CEM header is updated. The PTP 230 increments the CHC 542-b after completely reading one packet from the Storage Device 220. The CPC 542-a counter information is communicated to the Flash Arbiter 540, so that the Flash Arbiter 540 can make its decision as to which one of the channels should be selected to transmit its packet segments.

Referring again to FIG. 15, in some embodiment, a Host Insert Request 547 can be made by a Host Processor 99 of the System 100. The Host Processor 99 has direct access to the Storage Device 220 through the Host Processor 99 Interface, and tells the Transmit Segmenter 538 which host packet or host cell to fetch from the Storage Device 220 by providing the Transmit Segmenter 538 with the address of the host packet or the host cell.

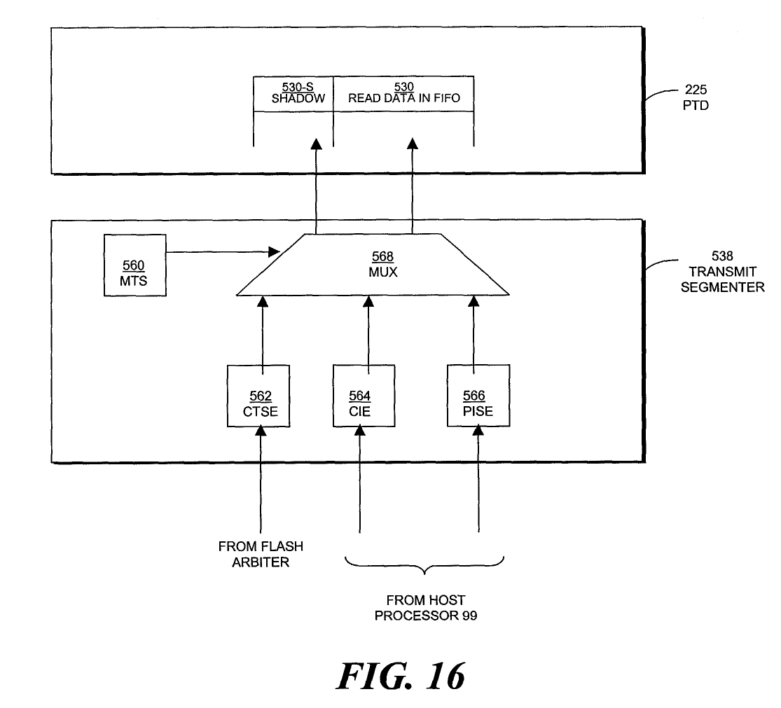

The PTP Transmit Segmenter 538 identifies triggering events for generating a packet segment by communicating with the Flash Arbiter 540, the Payload and Header Counters 542, the Flow Control Mechanism 546, and the Host Insert Request 547, and generates packet segment addresses to be entered into the PTD Input FIFO 530 in a manner conformant to the fairness goals described above. Referring to FIG. 16, in one embodiment, the PTP Transmit Segmenter 538 comprises a Master Transmit Segmenter 560 (MTS), Segmentation Engines, including a Transmit Segmentation Engine 562, a Cell Insert Engine 564, and a Packet Insert Segmentation Engine 566.

The Master Transmit Segmenter 560 decides which one of the Segmentation Engines 562, 564, or 566 should be activated and grants a permission to the selected Engine to write addresses of its requested data into the Input FIFO 530. For example, the three Segmentation Engines 562, 564, and 566 provide inputs to a Selector 568 (e.g., multiplexer) that is controlled by the Master Transmit Segmenter 560, and the Master Transmit Segmenter 560 can choose which Engine 562, 564, or 566 to activate. If the Master Transmit Segmenter 560 receives a signal that indicates that a valid Host Insert Request 547 is made and the Host Processor 99 is providing the address of the host data or the host cell in the Storage Device 220, the Master Transmit Segmenter 560 can select to activate either the Cell Insert Engine 564 or the Packet Insert Segmentation Engine 566 for the host cell and the host packet respectively.

The Master Transmit Segmenter 560 comprises a state machine that keeps track of the activation status of the Engines, and a memory, typically a RAM, that stores the address information of the selected channel received from the Flash Arbiter 540. The Transmit Segmentation Engine 562 processes all of the TDM data packets that move through the PTP 230. The Transmit Segmentation Engine 562 fetches their user-defined headers from the Headers Section 502 of the Storage Device 220, and selects their CEM headers and corresponding payload to orchestrate their transmission over the Network 115. The Packet Insert Segmentation Engine 566 and the Cell Insert Engine 564 receive the addresses of the host packet and the host cell from the Host Processor 99 respectively. Once selected, the Packet Insert Segmentation Engine 566 generates the addresses of the composite host packet segments so that the associated packet data may be retrieved from the Storage Device 220 by the PTD. Similarly, the Cell Insert Engine 564 generates the required addresses to acquire a host-inserted cell from Storage Device 220. Both the Packet Insert Segmentation Engine 566, and the Cell Insert Engine 564 have a mechanism to notify the Host Processor 99 when its inserted packet or cell has successfully been transmitted into Network 115.

Referring again to FIG. 15 the Link Updater 548 transfers the entries in the PTD Output FIFO 532 to the Data Packer FIFO 550 of the PTP 230 and updates the transfer information with the Transmit Segmenter 538. The Dynamic Data Packer 552 aligns unaligned entries in the Data Packer FIFO 550 before handing these entries to the PTP FIFO 554. For example, if the user-defined header of the entry data is not a full word, subsequent data must be realigned to fill the remaining space in the Data Packer FIFO 550 entry before it can be passed to the PTP FIFO 554. The Dynamic Data Packer 552 aligns the entry by filling the entry with the corresponding CEM header and the data from the Storage Device 220. Thus, each entry to the PTP FIFO 554 is aligned as a full word long and the content of each entry is recorded in the control field of the PTP FIFO 554. The Dynamic Data Packer 552 also provides residual data when a full word is not available from the entries in the Data Packer FIFO 550 so that the entries are all aligned as a full word.

In as much as the Transmit Segmenter 538 interleaves requests for packet segments between all transmit channels it is processing, there may be such an occurrence that the Dynamic Data Packer 552 requires more data to complete a PTP FIFO 554 entry for a given channel, yet the next data available in the Data Packer FIFO 550 pertains to a different channel. In this circumstance, the Dynamic Data Packer 552 will store the current incomplete FIFO entry as residual data for the associated channel. Later, when data for that channel again appears in the Data Packer FIFO 550, the Dynamic Data Packer 552 will resume the previously suspended packing procedure using both the channels stored residual data, and the new data from Data Packer FIFO 550. To perform this operation, the DPD 552 maintains residual storage memory as well as state and control information for all transmit data channels. The Dynamic Data Packer 552 also alerts the Transmit Segmenter 538, if the PTP FIFO 554 is becoming full. Accordingly, the Transmit Segmenter 538 stops making further data requests to prevent overflow of the Data Packer FIFO 550. The Data Packer FIFO 550 and the PTP FIFO 554 are connected through an arrangement of multiplexers that keep track of the residual information per channel within the Dynamic Data Packer 552.

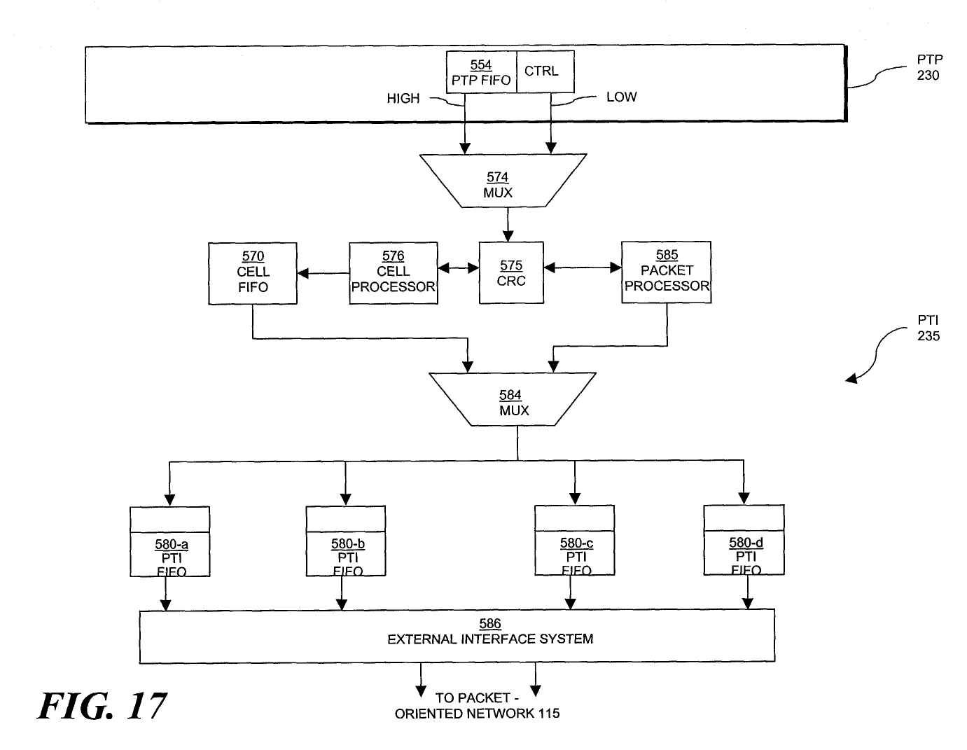

Referring to FIG. 17, the PTI 235 outputs the packet or cell received from the PTP 230 to the packet oriented network 115. In one embodiment, the PTP FIFO 554, as the interface between the PTP 230 and the PTI 235, outputs either cell entries or packet entries. Because of the difference in the size of the data path between the PTP 230 and the PTI 235, e.g. 8 bytes for the PTP 230 and 4 bytes for the PTI 235, the multiplexer, the Processor In MUX 574, sequentially reads each of the entries from the PTP FIFO 554 by separating each entry into a higher-byte entry and a lower-byte entry to align the data path of the PTI 235. If cell entries are outputted by the Processor In MUX 574, these entries are transmitted via a cell processing pipeline to the Cell Processor 576 that is coupled to the Cell FIFO 570. The Cell FIFO 570 then sends the Cell FIFO 570 entries out to one of the PTI FIFOs 580 after another multiplexer, Processor Out MUX 584, decides whether to transmit a cell or a packet. If packet entries are read out from the Processor In MUX 574, the packet entries are sent to a Packet Processor 585. In some embodiments, a Cyclic Redundancy Checker (CRC) 575 will calculate a Cyclic Redundancy Check value that can be appended to the output of either the Cell Processor 576, or the Packet Processor 585 prior to its transmission into Network 115, so that a remote packet or cell receiver, substantially similar to Packet Receiver 120 can detect errors in the received packets or cells. From the Packet Processor 585, the packet entries enter one of the PTI FIFOs 580. Although the system 100 has one physical interface to the Network 115, the PTI FIFO 580 corresponds to four logical interfaces. The External Interface System 586 has a controller that decides which one of the PTI FIFO 580 should be selected for transmission based on the identification of the selected PHY.

The Cell Processor 576 drains entries from the PTP FIFO 554 to build ATM cells to fill the PTI FIFOs 580. Once the Processor In MUX 574 outputs cell entries, the Cell Processor 576 communicates with the PTP FIFO 554 via the cell processing pipeline to pad the final cell for transmission and add the ATM header to the final cell before releasing the prior cell in the cell stream to the PTI FIFOs 580 due to one cell delay. In one particular embodiment, the Cell Processor 576 comprises a Cell Fill State Machine (not shown) and a Cell Drainer (not shown). The Cell Fill State Machine fills the Cell FIFO 570 with a complete cell and maintains its cell level information to generate a reliable cell stream. The Cell Drainer then transfers the complete cell in the Cell FIFO 570 to the PTI FIFOs 580 and applies the user-defined ATM cell header for each of the cells. In transmitting packets to the packet oriented network, in one particular embodiment, the entries received from the PTP FIFO 554 are narrowed from a 64 bit path to a 32 bit path by the Processor In MUX 574 under control of the Packet Processor 585 and fed directly to the PTI FIFOs 580 via the Processor Out MUX 584.

The PTI FIFOs 580 provides the packets (or cells) for transmission over the Packet-Oriented Network 115. In one particular embodiment, as shown in FIG. 17, the PTI FIFOs 580 comprise four separate PTI FIFO blocks, 580-a to 580-d. All four FIFO 580 blocks are in electrical communication with the External Interface System 586, but each of the FIFO 580 blocks has independent read, write, and FIFO count and status signals. In addition, each of the four PTI FIFOs 580 maintains a count of the total number of word entries in the FIFO memory 580 as well as the total number of complete packets stored in the FIFO memory 580, so that the PTI External Interface System 586 can use these counts when servicing transmission of the packets. For example, for the UTOPIA physical interface mode, only the total number of FIFO memory 580 entries is used, while for the POS/PHY physical interface mode, both the total number of the FIFO memory 580 entries as well as the total number of the complete packets stored in each of PTI FIFOs 580 are used to determine the transmission time for the packets. The PTI FIFOs 580 and the PTI External Interface System 586 are all synchronized to the packet transmit clock (PT_CLK), supplied from an external source to the PTI 235. Since packets can be of any length, such counts are necessary to flush each of the PTI FIFOs 580 when the end-of-packet has been written into the PTI FIFO memory 580.

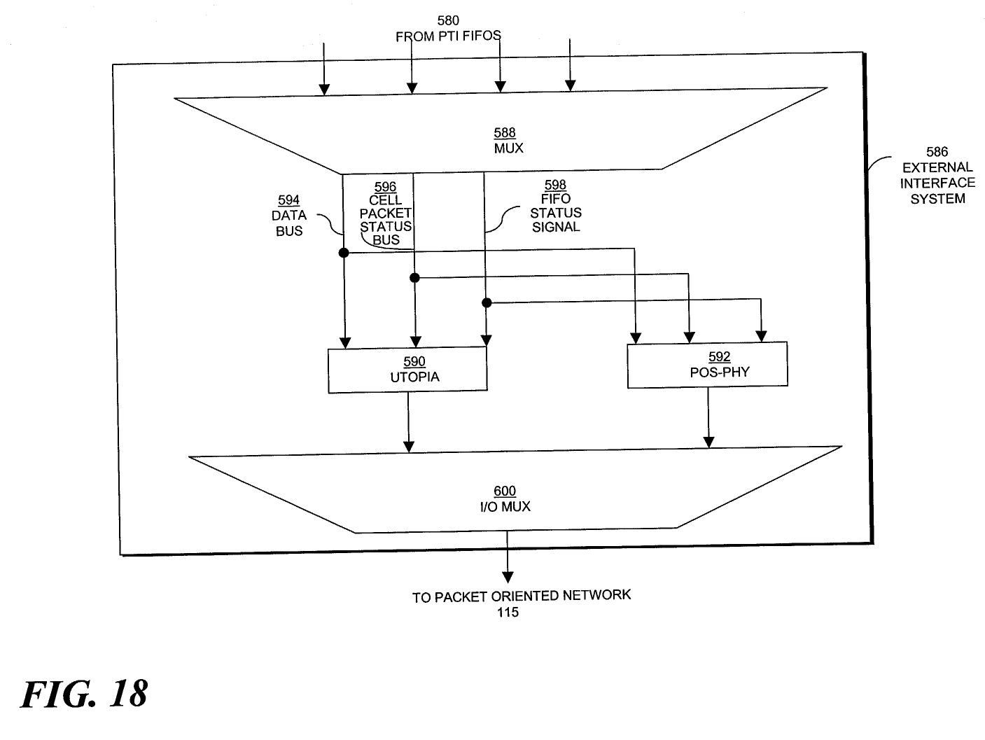

Referring to FIG. 18, the PTI External Interface System 586 provides polling and servicing of the packet streams in accordance with the pre-configured External Interface operating mode, such as the UTOPIA or the POS/PHY mode. In one particular embodiment, the External Interface operating mode is set during an initialization process of the System 100.

Referring again to FIG. 18, in one embodiment, a multiplexer, External Interface MUX 588, sequentially reads out the entries from the PTI FIFOs 580. The outputted entries are then transferred to the pre-selected External Interface controller, for example either the UTOPIA Interface Controller 590 or the POS/PHY Interface Controller 592 via the PTI FIFO common buses, comprising the Data Bus 594, the Cell/Packet Status Bus 596, and the FIFO Status Signal 598. A selector may be implemented using a multiplexer, I/O MUX 600, receiving inputs from either the UTOPIA Controller 590 or the POS/PHY Controller 592 and providing an output that is controlled by the user of the System 100 during the initialization process. The data and signals outputted from the I/O MUX 600 are then directed to the appropriate interfaces designated by the pre-selected External Interface operating mode.

As discussed previously, more than one interface to the Packet-Oriented Network 115 may be used to service the packet streams. Because the data rates of such packet streams may exceed the capacity of the packet-oriented network, in one particular embodiment, each of the packet streams can be split into segmented packet streams to be transferred across the packet-oriented network. For example, a single OC-48(c) signal travels at the data rate of 2.4 Gbps on a single channel. Typically such data rate exceeds the transmission rate of a common telecommunication carrier (e.g. 1 G-bit Ethernet) in a packet-oriented network. Thus, each of the data streams representative of the synchronous transport signals are inverse multiplexed into a multiple segmented packet streams and distributed over the pre-configured multiple interfaces to the Packet-Oriented Network 115.

In the other direction, referring again to FIG. 7, the Packet Receiver 120 receives packet streams from the Network 115 and parses various packet transport formats, for example a cell format over the UTOPIA interface or a pure packet format over the POS/PHY interface, to retrieve the CEM header and payload. The Packet Receive Interface (PRI) 250 can be configurable to an appropriate interface standard, such as POS/PHY or UTOPIA, for receiving packet streams from the Network 115. The PRP 255 performs the necessary calculations for packet protocols that incorporate error correction coding (e.g., the AAL5 CRC32 cyclical redundancy check). The PRD 260 reads data from the PRP 255 and writes each of the packets into the Jitter Buffer 270. The PRD 260 preserves a description associated with each packet including information from the packet header (e.g., location of the J1 byte for SONET signals).

In one embodiment, the PR 120 receives the packets from the Packet-Oriented Network 115 through the PRI 250, normalizes the packets and transfers them to the PRP 255. The PRP 255 processes the packets by determining a channel with which the packet is associated and removing a packet header from the packet payload, and then passes them to the PRD 260 to be stored in the Jitter Buffer 270 of the Jitter Buffer Management 265. The PR 120 receives a packet stream over the Packet-Oriented Network 115 with identifiers called the Tunnel Label, representing the particular interface and the particular network path it had used across the Network 115, and the virtual-channel (VC) Label, representing the channel information.

The PRI 250 receives the data from the packet oriented network and normalizes these cells (UTOPIA) or packets (POS/PHY) in order to present them to the PRP 255 in a consistent format. In a similar manner, more than one interface to the Packet-Oriented Network 115 may receive inverse-multiplexed packet streams, as configured during the initialization of the System 100, to be reconstructed into a single packet stream. Inverse multiplexing may be accomplished by sending packets of a synchronous signal substantially simultaneously over multiple packet channels. For example, the sequential packets of a source signal may be alternately transmitted over a predetermined number of different packet channels (e.g., four sequential packets sent over four different packet channels in a “round robin” fashion, repeating again for the next four packets.)

The jitter buffer performs, as required, any reordering of the received packets. Once the received packets are reordered, they may be recombined, or interleaved to reconstruct a representation of the transmitted signal. In one particular embodiment, the PRI 250 comprises a Data Formatter (not shown) and an Interface Receiver FIFO (IRF) (not shown). Once the PRI 250 receives the data, the Data Formatter strips off any routing tags, as well encapsulation headers, that are not useful to the PRP 255 and aligns the header stacks of MPLS, IP, ATM, Gigabit Ethernet, or similar types of network, and the CEM header to the same relative position. The Data Formatter then directs these formatted packets or cells to the IRF as entries. In one particular embodiment, the IRF allocates the first few bits for the control field and the remaining bits for the data field or the payload information. The control field contains information, such as packet start, packet end, data, that describes the content of the data field.

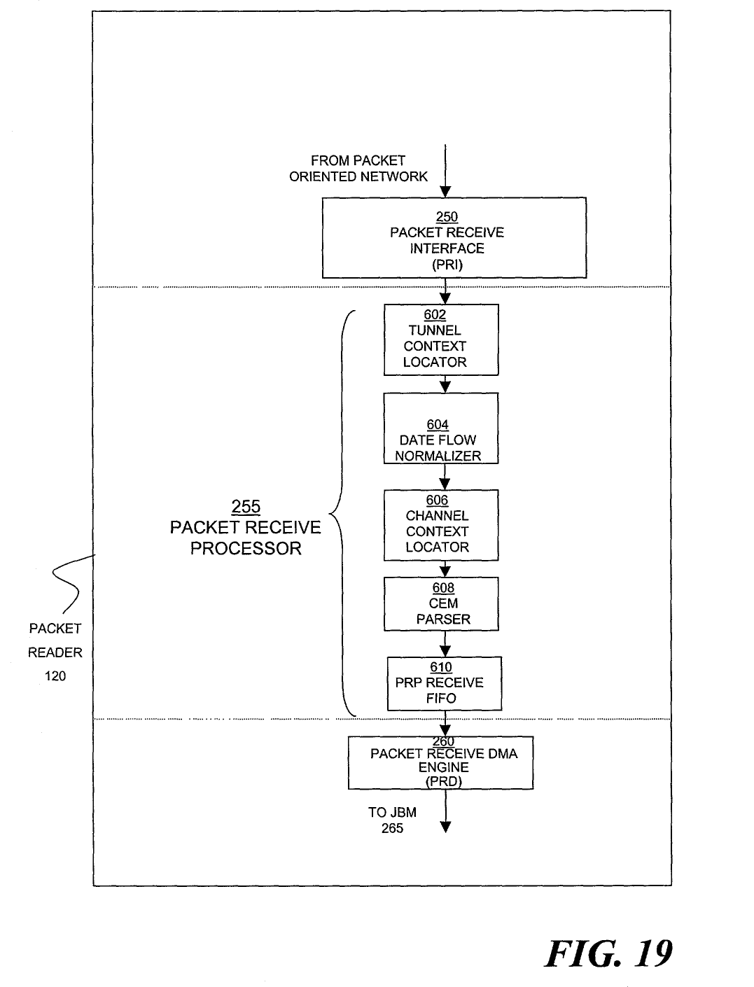

The PRP 255 drains the IRF entries from the PRI 250, parses out the CEM packets, strips off all headers and labels from the packets, and presents the header content information and the storage location information to the PRD 260. Referring to FIG. 19, in one embodiment, the PRP 255 comprises, a Tunnel Context Locator 602 (TCL) that receives the packets or cells from the PRI 250, locates the tunnel information, and then transfers these data to a Data Flow Normalizer 604 (DFN). The DFN 604 normalizes the data and these data are then transferred to a Channel Context Locator 606 (CCL), and then to a CEM Parser 608 (CP) and a PRP Receive FIFO 610, the interface between the PRP 255 and the PRD 260.

The PRP 255 is connected to the PRI 250 via a pipeline, where the data initially moves through the pipeline with a 32 bit wide data field and a 4 bit wide control field. The TCL 602 drains the IRF entries from the PRI 250, determines the Tunnel Context Index (TCI) of the packet segment or cell, and presents the TCI to the DFN 604, the next stage in the PRP 255 pipeline, before the first data word of the packet segment or cell is presented. After the DFN 604 receives its inputs, including data, control, and TCI, from the TCL 602, the DFN 604 alters these inputs to appear as a normalized segmented packet (NSP) format, so that the subsequent stages of the PRP 255 no longer have to worry about the differences between a packet and a cell.

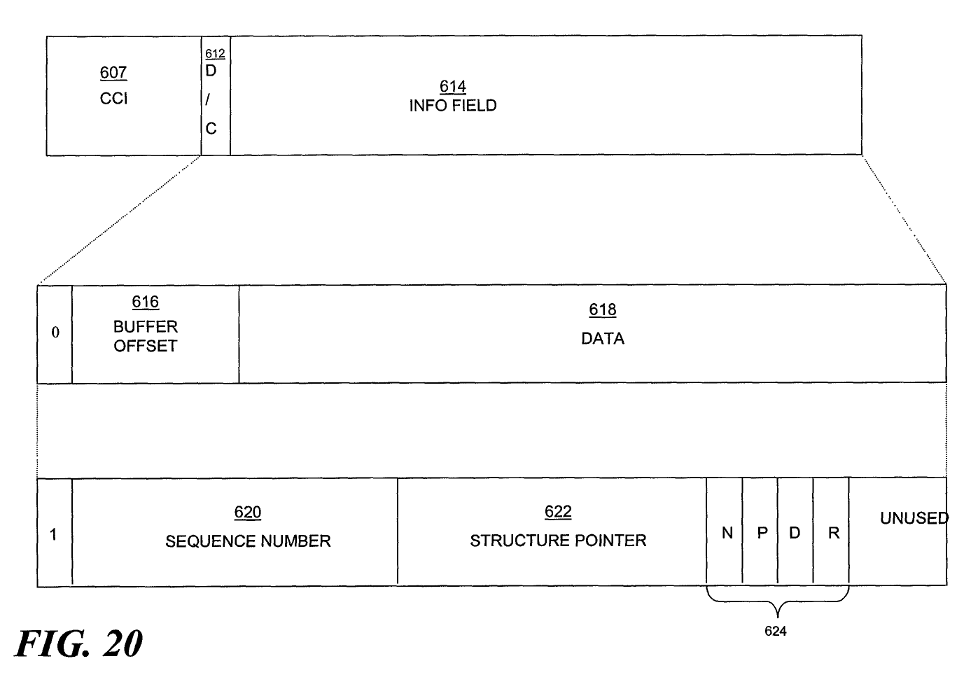

The CCL 606 receives a NSP from multiple tunnels by interleaving packet segments from different channels. For each tunnel, the CCL 606 locates the VC Label to identify an appropriate channel for the received NSP stream and discards any packet data preceding the VC Label. The pipeline entry containing the VC Label is replaced with the Channel Context Index 607 (CCI) (shown in FIG. 20) and marked with a PKT_START command. The CEM Parser 608 then parses the CEM header and the CEM payload. If the header is valid, the CEM header is written directly into a holding register that spills into the PRP Receive FIFO 610 on the next cycle. If the header is invalid, the subsequent data received on that channel is optionally discarded. In one particular embodiment, some packets are destined for the Host Processor 99. These packets are distinguished by their TCIs and the VC Labels.

For example, when a DATA command appears as the entry to the PRP Receive FIFO 610, the packet byte count along with the CCI 607 and the data field are written into the PRP Receive FIFO 610. The data path widens, so that a FIFO entry can be generated at every other cycle. When a PKT_END command is detected as the entry to the PRP Receive FIFO 610, the cumulative byte count and MOD bits from the control field are checked against expected values. If there is a match, a valid CEM payload has been received. Subsequently, once the last data is written into the PRP Receive FIFO 610, the stored CEM header is written into a holding register that spills into the PRP Receive FIFO 610 on the next cycle (which is always a PKT_START command that does not generate an entry). Information about the last data and the header are used along with the current state of Jitter Buffer 270 in the Jitter Buffer Management 265 (referring to FIG. 8) to compute the starting address of the packet in the Jitter Buffer 270.

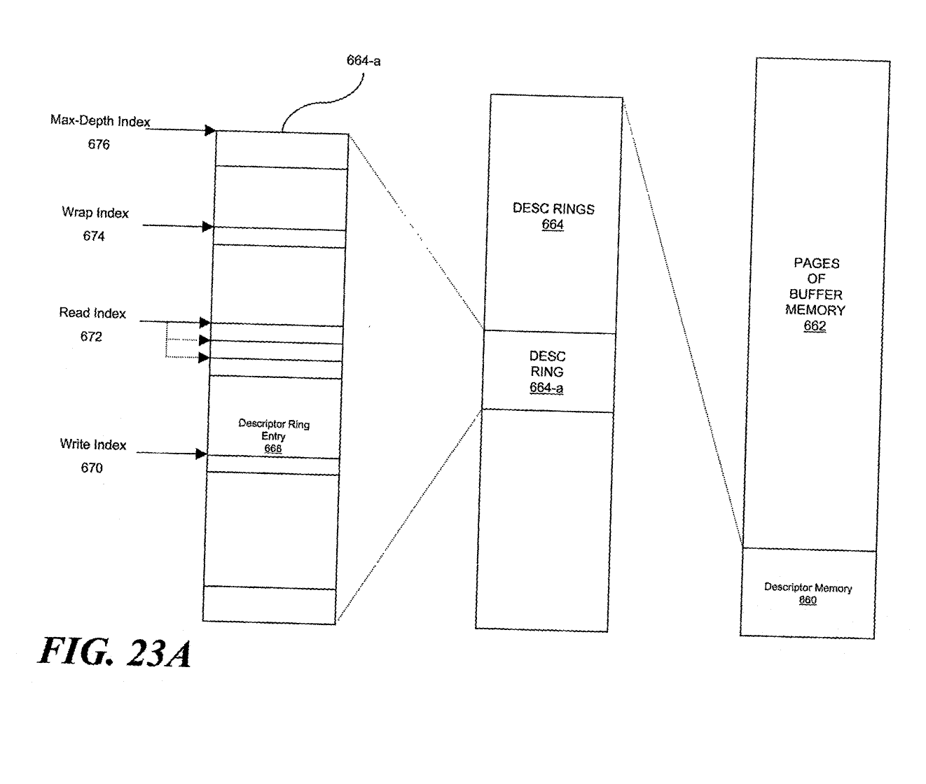

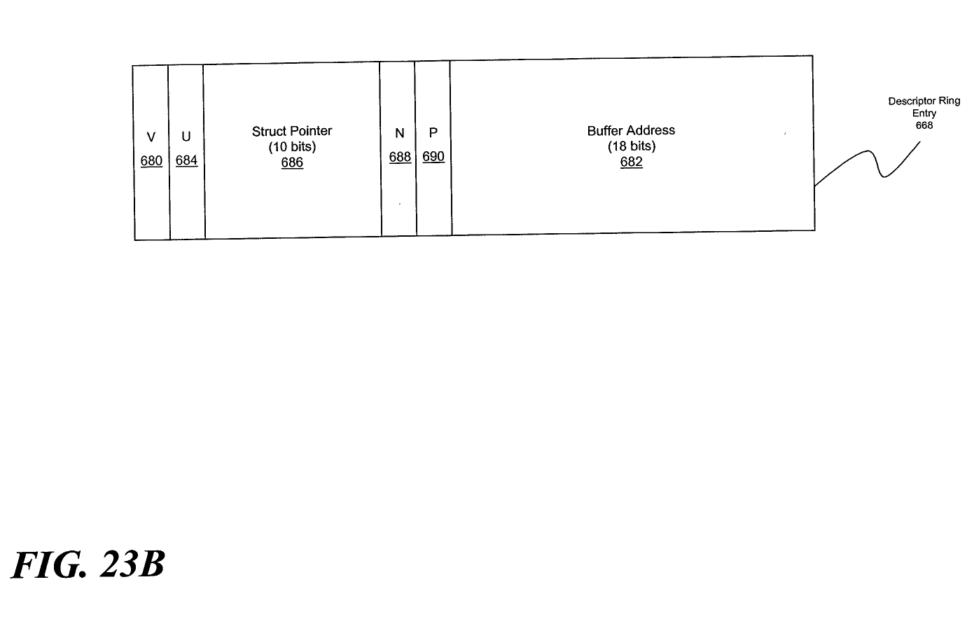

The CP 608 fills the PRP Receive FIFO 610 after formatting its entries. Referring to FIG. 20, in one particular embodiment, a PRP Receive FIFO 610 entry is formatted such that the entry comprises the CCI 607, a D/C bit 612, and a Info Field 614. The D/C bit 612 indicates whether the Info Field 614 contains data or control information. If the D/C bit 612 is equal to 0, the Info Field 614 contains a Buffer Offset Field 616 and a Data Field 618. The Buffer Offset Field 616 becomes the double word offset into one of the packet buffers of Buffer Memory 662 within the Jitter Buffer 270 (as shown in FIG. 23A). The Data Field 618 contains several bytes of data to be written into the Buffer Memory 662 within the Jitter Buffer 270. If the D/C bit 612 is equal to 1, the Info Field 614 contains the control information retrieved from the CEM header, such as a Sequence Number 620, a Structure Pointer 622, and the N/P/D/R bits 624. As long as the D/C bit 612 is set to 1, the last packet stored in the PRP Receive FIFO 610 is complete and the corresponding CEM header information is included in the PRP Receive FIFO 610 entry.

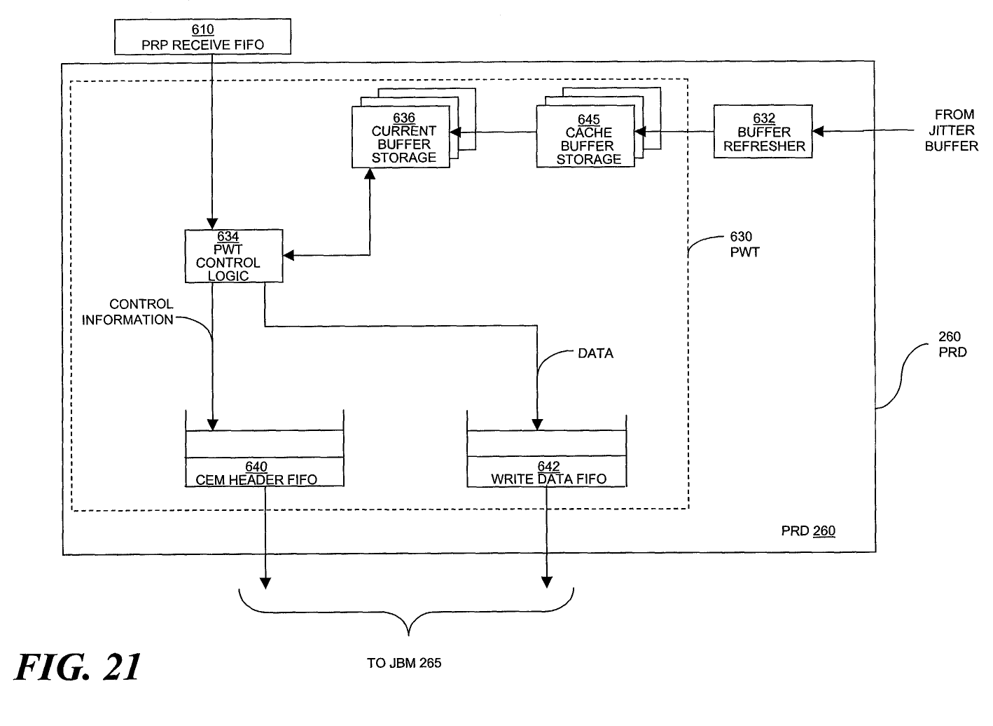

The PRD 260, as the interface between the PRP Receive FIFO 610 and the Jitter Buffer Management 265, takes the packets from the PRP 255 and writes the packets into the Jitter Buffer 270 coupled to the Jitter Buffer Management 265. Referring to FIG. 21, in one embodiment, the PRD 260 comprises a Packet Write Translator 630 (PWT) (shown in phantom) that drains the packets in the PRP Receive FIFO 610, and a Buffer Refresher 632 (BR) that is in communication with the PWT 630. In one particular embodiment, the PWT 630 comprises a PWT Control Logic 634 that receives packets from the PRP Receive FIFO 610. The PWT Control Logic 634 is in electrical communication with a Current Buffer Storage 636, a CEM Header FIFO 640, and a Write Data In FIFO 642. The Current Buffer Storage 636, preferably a RAM, is in further electrical communications with a Cache Buffer Storage 645, preferably a RAM, which receives its inputs from the Buffer Refresher 632.

The PWT Control Logic 634 separates out the header information from the data information. In order to keep track of the data information with the corresponding header information before committing any data information to the Buffer Memory 662 in the Jitter Buffer 270 (as shown in FIG. 23A), the PWT Control Logic 634 utilizes the Current Buffer Storage 636 and the Cache Buffer Storage 645. The data entries from the PRP Receive FIFO 610 can have the Buffer Offset 616 (as shown in FIG. 20) converted to a real address by the PWT Control Logic 634 before being posted in the Write Data In FIFO 642. The control entries from the PRP Receive FIFO 610 are packet completion indications that can be posted in the CEM Header FIFO 640 by the PWT Control Logic 634. If the target FIFO, either the CEM Header FIFO 640 or the Write Date In FIFO 642, is full, the PWT 634 stalls, which in turn causes a backup in the PRP Receive FIFO 610. By calculating the duration of such stalls over time, the average depth of the PRP Receive FIFO 610 can be calculated.

The Buffer Refresher 632 assists the PWT 630 by replenishing the Cache Buffer Storage 645 with a new buffer address. In order to write data into the Jitter Buffer 270, one vacant buffer address is stored in the Current Buffer Storage 636 (typically RAM with 48 entries that correspond to the number of channels). The buffer address is held in the Current Buffer Storage 636 until the PWT Logic 634 finds a packet completion indication for the corresponding channel in the PRP Receive FIFO 610. Once the End-of-Packet control word is received in the corresponding header entry of the PRP Receive FIFO 610, the data is committed to the Buffer Memory 662 of the Jitter Buffer 270. The next vacant buffer address is held at the Cache Buffer Storage 645 to refill the Current Buffer Storage 636 with a new vacant address as soon as the Current Buffer Storage 636 commits the buffer address to the data received. When the End-of-Packet control word is received, meaning the packet is completed, then one of the Descriptor Ring Entry 668 is pulled out to write the buffer address in the Entry 668 and the data is effectively committed into the Buffer Memory 662.

In one particular implementation, the Buffer Refresher 632 monitors the Jitter Buffer Management 265 as a packet is being written into a page of the Buffer Memory 662. The Jitter Buffer Management 265 selects one of the Descriptor Ring Entries 668 to record the address of the page of the Buffer Memory 662. As the old address in the selected Descriptor Ring Entries 668 is being replaced by this new address, the Buffer Refresher 632 takes the old address and places the old address in the Cache Buffer Storage 645. The Cache Buffer Storage 645 then transfers this address to the Current Buffer Storage 636 after the Current Buffer Storage 636 uses up its buffer address.

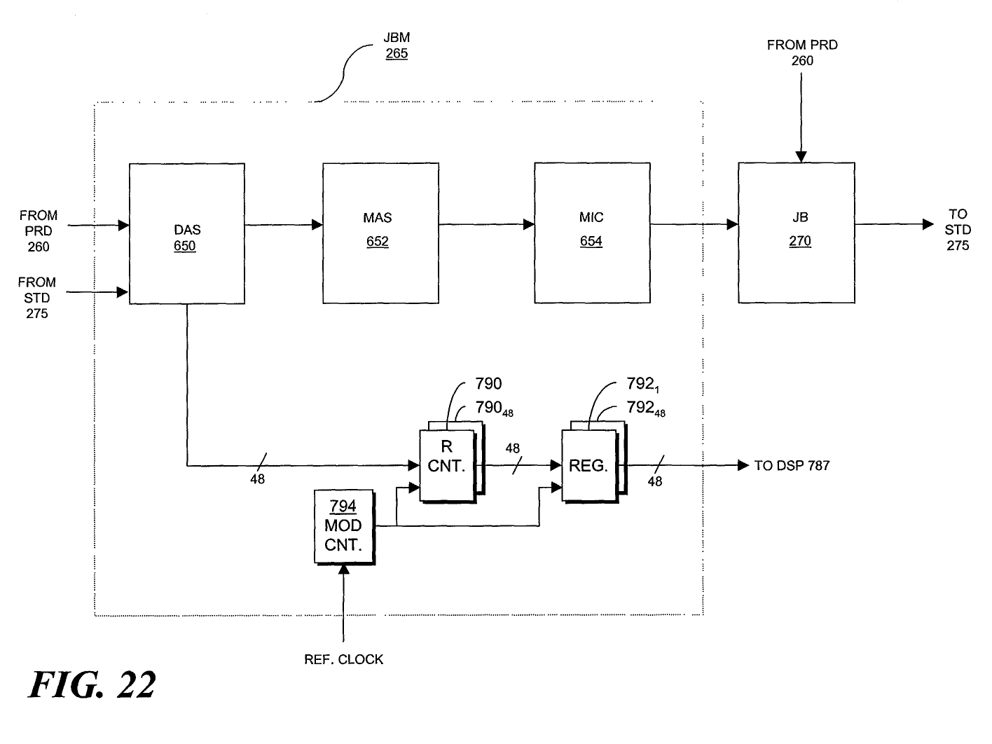

Referring to FIG. 8, in one embodiment the Jitter Buffer Management 265 provides buffering to reduce the impact of jitter introduced within the Packet-Oriented Network 115. Due to the asynchronous nature of Jitter Buffer 270 filling by the PRD 260 relative to the Jitter Buffer 270 draining by the Synchronous Transmit DMA Engine 275, the Jitter Buffer Management 265 provides hardware to ensure that the actions by the PRD 260 and the Synchronous Transmit DMA Engine 275 do not interfere with one another. Referring to FIGS. 22 and 23A, the Jitter Buffer Management 265 is coupled to the Jitter Buffer 270. The Jitter Buffer 270 is preferably a variable buffer that comprises at least two sections; a section for Descriptor Memory 660 and a section for Buffer Memory 662. The Jitter Buffer Management 265 includes a Descriptor Access Sequencer 650 (DAS) that receives packet completion indications from the PRD 260 and descriptor read requests from the Synchronous Transmit DMA Engine 275. The DAS 650 converts these inputs into descriptor access requests and passes these requests to a Memory Access Sequencer 652 (MAS). The Memory Access Sequencer 652 in turn converts these requests into actual read and write sequences to Jitter Buffer 270. Ultimately the Memory Interface Controller 654 (MIC) performs the physical memory accesses as requested by the Memory Access Sequencer 652.

In some embodiments, the Jitter Buffer Management 265 includes a high-rate Received Packet Counter (R CNT.) 790₁-790₄₈ (generally 790), incrementing a counter, on a per channel basis, in response to a packet being written into the Jitter Buffer 270. Thus, the Received Packet Counter 790 counts packets received for each channel during a sample period regardless of whether the packets were received in order. Periodically, the contents of the Received Packet Counter 790 are transferred to an external Digital Signal Processing functionality (DSP) 787. In one embodiment, the Received Packet Counter 790 transmits its contents to a first register 792₁-792₄₈ (generally 792) on a per-channel basis. Thus, the first register 792 stores the value from the Received Packet Counter 790, while the Received Packet Counter 790 is reset. The stored contents of the first register 792 are transmitted to an external DSP 787. The received counter reset signal and the received register store signal can be provided by the output of a modulo counter 794. In some embodiments, the register output signals for each channel are serialized, for example by a multiplexer (not shown).

Referring to FIG. 23A, an embodiment of the Descriptor Memory 660 comprises the Descriptor Rings 664, typically ring buffers, that are allocated for each of the channels. For example, in one particular embodiment, the Descriptor Memory 660 comprises the same number of the Descriptor Rings 664 as the number of channels. Each of the Descriptor Rings 664 may contain a multiple number of Descriptor Ring Entries 668. Each of the Descriptor Ring Entries 668 associates with one page of the Buffer Memory 662 present in the Jitter Buffer 270. Thus, each one of the Descriptor Ring Entries 664 contains information about a particular packet in the Jitter Buffer 270, including the J1 offset and N/P bit information obtained from the CEM header of the packet, and address of the associated Buffer Memory 662 page. When a packet completion indication arrives from the PRD 260, the Sequence Number 620 (shown in FIG. 20) is used by the DAS 650 along with the CCI 607 to determine which Descriptor Ring 664 and further which Descriptor Ring Entry 668 should be used to store information about the associated packet within the Jitter Buffer 270. In addition, each of the Descriptor Rings 664 includes several indices, such as a Write Index 670, a Read Index 672, a Wrap Index 674, and a Max-Depth Index 676, which are used to adjust the depth of the Jitter Buffer 270.

Referring to FIG. 23B, a particular embodiment of the Descriptor Ring Entry 668, includes a V Payload Status Bit 680 which is set to indicate that a Buffer Address 682 contains a valid CEM payload. Without the V Payload Status Bit 680, the payload is considered missing from the packet. A U Underflow Indicator Bit 684 indicates that the Jitter Buffer 270 experienced underflow, meaning, for example, too few number of packets were stored in the Jitter Buffer 270 so that the Synchronous Transmit DMA Engine 275 took out the packets from the Jitter Buffer 270 faster than the PRD 260 filled up the Jitter Buffer 270. A Structure Pointer 686, a N Negative Stuff Bit 688, and a P Positive Stuff Bit 690 are copied directly from the CEM header of the referenced packet. The remainder of the Descriptor Ring 664-a is allocated for the Buffer Address 682.

Referring again to FIG. 23A, in some embodiments, each Descriptor Ring 664 represents a channel, and creates a Jitter Buffer 270 with one page of the Buffer Memory 662 for that particular channel. In one particular embodiment, the Buffer Memory 662 is divided into the same number of evenly sized pages as the number of the channels maintained within System 100. Each page, in turn, may be divided into a multiple of smaller buffers such that there may be a one to one correspondence between buffers and Descriptor Rings Entries 668 associated with the respective packets. Such pagination is designed to prevent memory fragmentation by requiring the buffers allocated within one page of the Buffer Memory 662 to be assigned to only one of the Descriptor Rings 664. However, each of the Descriptor Rings 664 can draw buffers from multiple pages of the Buffer Memory 662 to accommodate higher bandwidth channels.

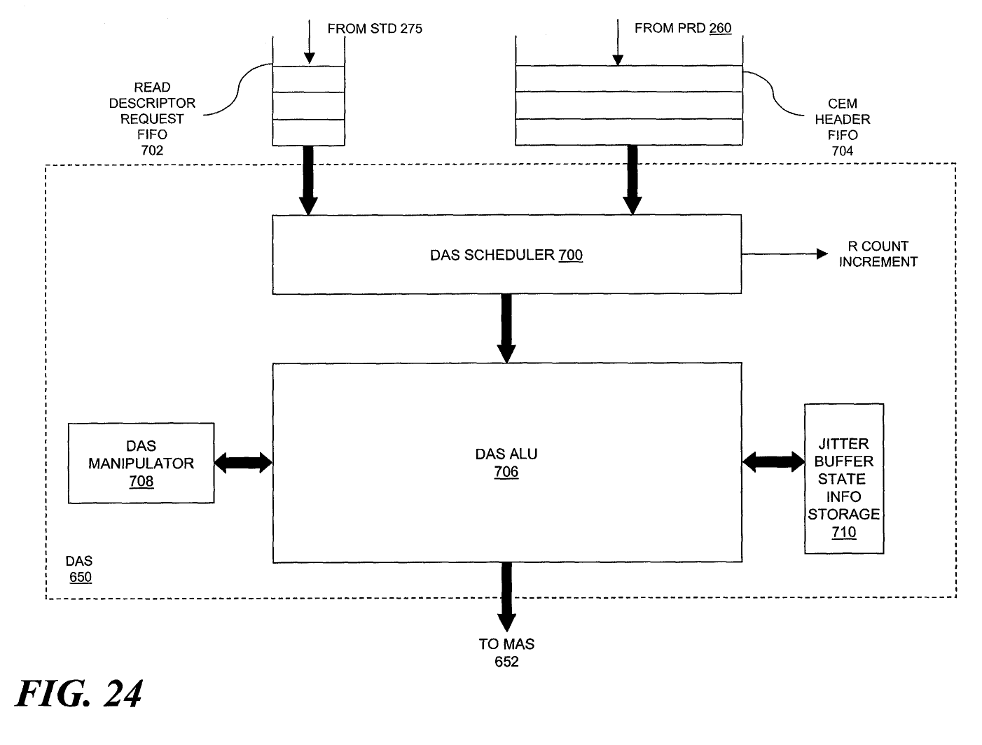

The DAS 650 services requests to fill and drain entries from the Jitter Buffer 270 while keeping track of the Jitter Buffer state information. Referring to FIG. 24, in one particular embodiment, the DAS 650 comprises a DAS Scheduler 700 that receives its inputs from two input FIFOs, a Read Descriptor Request FIFO 702 (RDRF) and a CEM Header FIFO 704 (CHF), a DAS Arithmetic Logic Unit 706 (ALU), a DAS Manipulator 708, and a Jitter buffer State Info Storage 710. The Read Request FIFO 702 is filled by the Synchronous Transmit DMA Engine 275, and the CEM Header FIFO 704 is filled by the PRD 260. The DAS Scheduler 700 receives a notice of valid CEM packets from the PRD PWT 630 via the messages posted in the CEM Header FIFO 704. The DAS Scheduler 700 also receives requests from the Synchronous Transmit DMA Engine 275 to read or consume the Descriptor Rings Entries 668, and such requests are received as the entries to the Read Request FIFO 702.

Referring still to FIG. 24, the DAS ALU 706 receives inputs from the DAS Scheduler 700, communicates with the DAS Manipulator 708 and the Jitter buffer State Information Storage 710, and ultimately sends out its outputs to the MAS 652. The Jitter buffer State Information Storage 710, preferably a RAM, tracks all dynamic elements of the Jitter Buffer 270. The DAS ALU 706 is a combinatorial logic that optimally computes the new Jitter Buffer read and write locations in each of the Descriptor Rings 664. More specifically, the DAS ALU 706 simultaneously computes the descriptor address and the new state information for each of the channels based on different commands.

For example, referring to FIGS. 23A, 23B, and 24, a READ command computes the descriptor index for reading one of the Descriptor Ring Entries 668 from the Jitter Buffer 270, and subsequently stores the new state information in the JB State Storage 710. After reading one of the Descriptor Rings Entries 668, the Read Index 672 is incremented and the depth of the Jitter Buffer 270, maintained within the JB State Storage 710, is decremented. If the depth was zero prior to decrementing the Jitter Buffer 270 depth, then an UNDER_FLOW signal is asserted for use by the DAS Manipulator 708 and the U bit 684 of the Descriptor Ring Entry 668, set to a logic one. If the Read Index 672 matches the Wrap Index 674 after incrementing, the Read Index 672 is cleared to zero to wrap the Descriptor Ring 664 to protect from overflow by preventing the depth of the Jitter Buffer 270 from reaching the Max-Depth Index 676.

In some embodiments, the Max-Depth Index is not used in calculation of the depth of the Jitter Buffer 270. Instead, the Wrap Index 674 alone is used to wrap the Descriptor Ring 664 whenever the depth reaches a certain predetermined level.

A packet completion indication command causes the DAS ALU 706 to compute the descriptor index for writing one of the Descriptor Ring Entries 668 into the Jitter Buffer 270 and subsequently stores the new state information in the JB State Storage 710. After writing one of the Descriptor Rings Entries 668, the Write Index 670 is incremented and the depth of the Jitter Buffer 270, maintained within the JB State Storage 710, is incremented. If the depth of the Jitter Buffer 270 equals the maximum depth allocated for the Jitter Buffer 270, an OVER_FLOW signal is asserted for the DAS Manipulator 708. In one particular implementation, over flow occurs when the PRD 260 inputs too many packets to be stored in the Jitter Buffer 270, so that the Synchronous Transmit DMA Engine 275 is unable to transfer the packets in a timely manner. If the Write Index 670 matches the Wrap Index 674 after incrementing the Write Index 670, the Write Index 670 is cleared to zero to wrap the ring to prevent overflow.

Referring again to FIG. 24, the DAS Manipulator 708 communicates with the DAS ALU 706 and decides if the outcome of the DAS ALU 706 operations will be committed to the Jitter Buffer State Information Storage 710 and the Descriptor Memory 660. The goal of the DAS Manipulator 708 is to first select a Jitter Buffer depth that can accommodate the worst possible jitter expected in the packet oriented network. Then, the adaptive nature of the Jitter Buffer 270 can allow convergence to a substantially low delay based on how the Network 115 actually behaves.

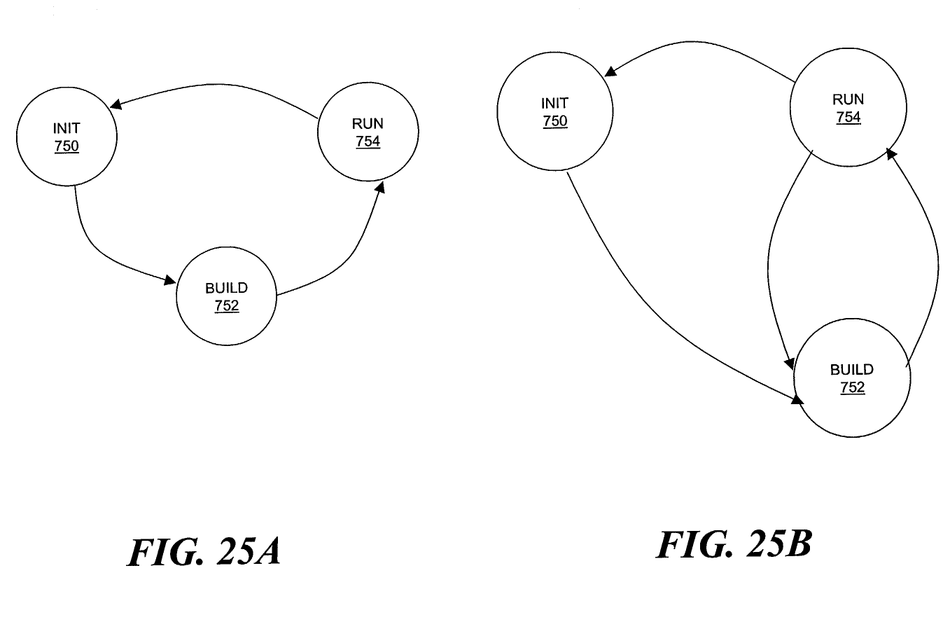

Referring to FIGS. 25A and 25B (and FIGS. 23A and 24 for reference), in one particular embodiment, the Jitter Buffer 270 can operate in three modes: an INIT Mode 750, a RUN Mode 754, and a BUILD Mode 752, and can be configured with either a static (as shown in FIG. 25A) or dynamic (as shown in FIG. 25B) size. Referring to FIGS. 25A and 25B, the Jitter Buffer 270 is first set to the INIT Mode 750 when a channel is initially started or otherwise in need of a full initialization. When in the INIT Mode 750, the Write Index 670 stays at the same place to maintain a packet synchronization while the Read Index 672 proceeds normally until it drains the Jitter Buffer 270. Once the Jitter Buffer 270 experiences an underflow condition, the Jitter Buffer 270 then proceeds to the BUILD Mode 752. More specifically, in the static-configured Jitter Buffer 270, if a read request is made when the Jitter Buffer 270 is experiencing an underflow condition, as long as the packets are synchronized, the Jitter Buffer 270 state proceeds to the BUILD Mode 752 from the INIT mode 750. In another implementation, in the dynamic-configured Jitter Buffer 270, if a read request is made when the Jitter Buffer 270 is experiencing an underflow condition, the Jitter Buffer 270 state proceeds to the BUILD Mode 752 from the INIT mode 750.

In the BUILD Mode 752 the Read Index 672 remains at the same place for a specified amount of time while the Write Index 670 is allowed to increment as new packets arrive. This has the effect of building out the Jitter Buffer 270 to a predetermined depth. Referring to FIG. 25A, if the Jitter Buffer 270 is configured to be static, the Jitter Buffer 270 remains in BUILD Mode 752 for a number of packet receive times equal to half of the total entries in the Jitter Buffer 270. The state then proceeds to the RUN Mode 754 where it remains until such time that the DAS Manipulator 708 may determine that a complete re-initialization is required. Referring to FIG. 25B, if the Jitter Buffer 270 is configured to be dynamic, the Jitter Buffer 270 remains in BUILD Mode 752 for a number of packet receive times equal to that of a user configured value which is substantially less than the anticipated final depth of the Jitter Buffer 270 after convergence. The Jitter Buffer 270 state then proceeds to the RUN Mode 754.

During RUN Mode 754, the Jitter Buffer 270 is monitored for an occurrence of underflow. Such an occurrence causes the state to return to BUILD Mode 752 where the depth of the Jitter Buffer 270 is again increased by an amount equal to that of the user configured value. By iteratively alternating between RUN Mode 754 and BUILD Mode 752, and enduring a spell of underflows and consequent build manipulations, a substantially small average depth is created for the Jitter Buffer 270.

As discussed briefly, a resynchronization—a complete re-initialization of the Jitter Buffer 270—triggers the Jitter Buffer 270 to return its state from the RUN Mode 751 to the INIT Mode 750. In the Jitter Buffer 270, a resynchronization is triggered when a resynchronization count reaches a predetermined threshold value.

Referring again to FIG. 22, the MAS 652 arbitrates access to the Jitter Buffer Management 265 in a fair manner based on the frequency of the requests made by the Synchronous Transmit DMA Engine 275 and the data access made by the PRD 260. The MIC 654 controls the package pins connected to the Jitter Buffer 270 to service access requests from the MAS 652.

In some embodiments, the Telecom Transmit Processor 130 is synchronized to a local physical reference clock source (e.g., a SONET minimum clock). Under certain conditions, however, the Telecom Transmit Processor 130 may be required to synchronize a received data stream to a reference clock with an accuracy greater than the physical reference clock source. For operational conditions in which the received signal was generated with a timing source having an accuracy greater than the local reference clock, the received signal can be used to increase the timing accuracy of the Telecom Transmit Processor 130.

In one embodiment, adaptive timing recovery is accomplished by generating a pointer adjustment signal based upon a timing relationship between the received signal and the rate at which received information is “played out” of a receive buffer. For example, when the local reference clock is too slow, data is played out slower than a nominal rate at which the data is received. To compensate for the slower reference clock, the pointer adjustment signal induces a negative pointer adjustment, to increase the rate of the played out information by one byte, decreasing the play-out period. Similarly, when the local reference clock is too fast, the pointer adjustment signal induces a positive pointer adjustment, effectively adding a stuff byte to the played out information, increasing the play-out period, thereby decreasing the play-out rate. Accordingly, the play-out rate is adjusted, as required, to substantially synchronize the play-out rate to the timing relationship of the originally transmitted signal. In one embodiment in which the received signal includes a SONET signal, the N and P bits of the emulated SONET signal are used to accomplish the negative and positive byte stuff operations.

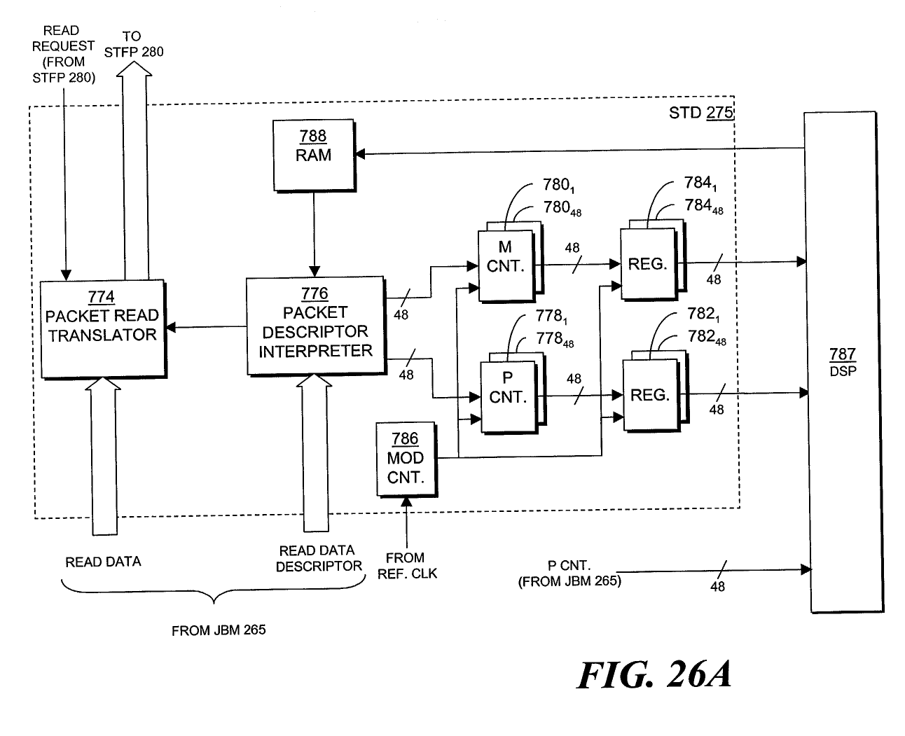

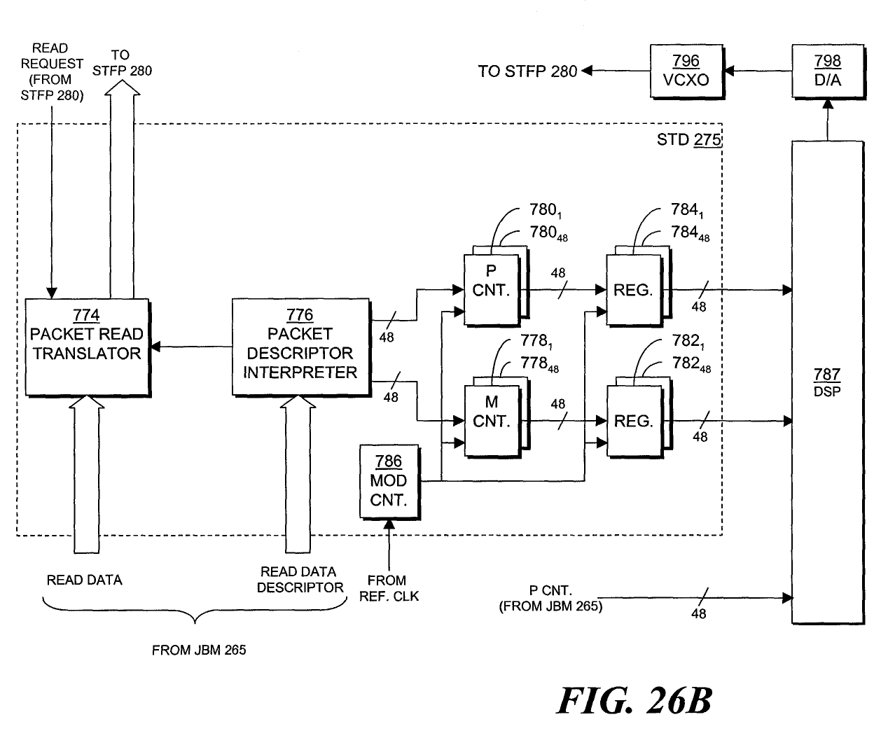

Referring now to FIG. 26A, in one embodiment, the STD 275 includes a packet-read translator 774 receiving read data from the JBM 265 in response to a read request signal received from the STFP 280 and writing the read data to a FIFO for use by the STFP 280. The packet-read translator 774 also receives an input from a packet descriptor interpreter 776. The packet descriptor interpreter 776 reads from the JBM 265 the data descriptor associated with the data being read by the packet read translator 774. The packet descriptor interpreter 776 also Monitors the number packets played and generates a signal identifying packets played out from JBM so that a count Packets Played (P) 778 may be incremented.

The packet descriptor interpreter 776 determines that a packet has been played, for example by examining the data valid bit 680 (FIG. 23B) within the descriptor ring entry 668 (FIG. 23B). The packet descriptor interpreter 776 transmits a signal to a high-rate Played Packet Counter 778, in turn, incrementing a count value, in response to a valid packet being played out (e.g., valid bit indicating valid packet). In one embodiment, the STD 275 includes one Played Packet Counter (P CNT.) 778₁-778₄₈ (generally 778) per channel. Thus, the Played Packet Counter 778 counts packets played out on each channel during a sample period. Periodically, the contents of the Played Packet Counter 778 are transferred to an external Digital Signal Processor (DSP) 787. In one embodiment, the Played Packet Counter 778 transmits its contents to a second register 782₁-782₄₈ (generally 782) on a per-channel basis. Thus, the second register 782 stores the value from the Played Packet Counter 778, while the Played Packet Counter 778 is reset. The stored contents of the second register 782 are transmitted to the DSP 787. The played counter reset signal and the played register store signal can be provided by the output of a modulo counter 786. In some embodiments, the register output signals for each channel are serialized, for example by a multiplexer (not shown).

The Packet Descriptor Interpreter 776 also determines that a packet has been missed, for example by examining the data valid bit 680 (FIG. 23B) within the descriptor ring entry 668 (FIG. 23B). The packet descriptor interpreter 776 transmits a signal to a high-rate Missed Packet Counter 780, in turn, incrementing a count value, in response to an invalid, or missing packet (e.g., valid bit indicating invalid packet). In one embodiment, the STD 275 includes one Missed Packet Counter (M CNT.) 780₁-780₄₈ (generally 780) per channel. Thus, the Missed Packet Counter 780 counts packets not received on each channel during a sample period. Periodically, the contents of the Missed Packet Counter 780 are transferred to the DSP 787. In one embodiment, the Missed Packet Counter 780 transmits its contents to a third register 784₁-784₄₈ (generally 784) on a per-channel basis. Thus, the Missed Packet Counter 780 stores the value from the Missed Packet Counter 780, while the Missed Packet Counter 780 is reset. The stored contents of the Missed Packet Counter 780 are transmitted to the DSP 787. The missing packet counter reset signal and the third register store signal can be provided by the output of the modulo counter 786. In some embodiments, the register output signals for each channel are serialized, for example by a multiplexer (not shown).

The DSP 787 receives inputs from each of the first, second, and third registers 792, 782, 784, containing the received packet count, the played packet count, and the missed packet count, respectively. The DSP 787 uses the received count signals and knowledge of the fixed packet length, to determine a timing adjust signal. In one embodiment, the DSP is a Texas Instruments, Dallas, Tex., part no. TMS320C54X. The DSP 787 then transmits to a memory (RAM) 788 a pointer adjustment value, as required, for each channel. The DSP implements a source clock frequency recovery algorithm. The algorithm determines a timing correction value based on the received counter values (packets received, played, and missed). In one embodiment, the algorithm includes three operational modes: acquisition mode to initially acquire the timing offset signal; steady state mode, to maintain routine updates of the timing offset signal; and holdover mode, to disable updates to the timing offset signal. Holdover mode may be used for example, during periods when packet arrival time is sporadic, thus avoiding unreliable timing recovery.

In one embodiment, the transmit signal includes two bits of information per channel representing a negative pointer adjustment, a positive pointer adjustment, or no pointer adjustment. The Packet Descriptor Interpreter 776, in turn, reads the pointer adjustment values from the RAM 788 and inserts a pointer adjustment into the played-out packet descriptor, as directed by the read values.

The JBM 265 maintains a finite-length buffer, per channel, representing a sliding window into which packets received relating to that channel are written. The received packets are identified by a sequence number identifying the order in which they should be played out, ultimately, to the telecom bus. If the packets are received out of order, a later packet (e.g., higher sequence number) is received before an earlier packet (e.g., lower sequence number), a placeholder for the out-of-order packet can be temporarily allocated and maintained within the JBM 265. If, however, the out-of-order packet is not received within a predetermined period of time (e.g., approximately +/−1 milliseconds as determined by the predetermined JBM packet depth and the packet transfer rate), then the allocated placeholder will be essentially removed from the JBM 265 and the packet will be declared missing. Should the missing packet show up at a later time, the JBM 265 can ignore the packet.

In another embodiment, referring now to FIG. 26B, adaptive timing recovery is achieved by controlling a controllable timing source (e.g., a Voltage-controlled Frequency Oscillator (VCXO) 796) with a timing adjustment signal based upon a timing relationship of the received signal and the rate at which received information is “played out” of a receive buffer. For example, when the output of the local controllable timing source (VCXO) 796 is too slow, a VCXO input signal (e.g., a voltage level) is adjusted upward or downward (as required), thereby increasing the frequency signal output by the VCXO 796. The DSP 787 tracks the received, played, and missed packet counts, as described in relation to FIG. 26A and generates a digital signal relating to the difference between the packet play out rate and the packet receive rate. The DSP 787 transmits the difference signal to a digital-to-analog converter (DAC) 798. The DAC 798, in turn, converts the digital difference signal to an analog representation of the difference signal, which, in turn, drives the VCXO 796. In one embodiment, the DAC 798 is an 8-bit device. In other embodiments, the DAC 798 can be a 12-bit, 16-bit, 24-bit, and a 32-bit device.

In one embodiment, the particular requirements of the VCXO 796 satisfy at a minimum, the Stratum 3 free-run and pull-in requirements (e.g., +/−4.6 parts per million). In some embodiments, the VCXO 796 operates, for example, at nominal frequencies of 77.76 MHz or 155.52 MHz.

Referring yet again to FIG. 8, the Telecom Transmit Processor 130 receives packet information from the Jitter Buffer 270. The Telecom Transmit Processor 130 includes a Synchronous Transmit DMA engine (STD) 275 reading data from the Jitter Buffer Management 265 and writing data to the Synchronous Transmit Frame Processor (STFP) 280. The Synchronous Transmit DMA Engine 275 maintains available memory storage space, storing data to be played out, thereby avoiding an under-run condition during data playout. For synchronous signals, the Synchronous Transmit DMA Engine 275 reads the received packet data from the Jitter Buffer 270 at a constant rate regardless of the variation in time at which the packets were originally stored. The Synchronous Transmit Frame Processor 280 receives packet data from the Synchronous Transmit DMA Engine 275 and reconstitutes signals on a per-channel basis from the individual received packet streams. The Synchronous Transmit Frame Processor 280 also recombines the reconstituted channel signals into an interleaved, composite telecom bus signal. For example, the Synchronous Transmit Frame Processor 280 may time-division multiplex the information from multiple received channels onto one or more TDM signals. The Synchronous Transmit Frame Processor 280 also passes information that is relevant to the synchronous transport signal, such as framing and control information transferred through the packet header. The SONET Transmit Telecom Bus (STTB) 285 receives the TDM signals from the Synchronous Transmit Frame Processor 280 and performs conditioning similar to that performed by the Synchronous Receive Telecom Bus Interface 200. Namely, the Synchronous Transmit Telecom Bus 285 reorders timeslots as required and transmits the reordered timeslots to one or more telecom busses. The Synchronous Transmit Telecom Bus 285 also receives certain signals from the telecom bus, such as timing, or clock signals. The Synchronous Transmit Telecom Bus 285 also computes parity and transmits a parity bit with each of the telecom signals.

The SONET transmit DMA engine (STD) 275 reads data from the Jitter Buffer Management 265 in response to a read-request initiated by the Synchronous Transmit Frame Processor 280. The Synchronous Transmit DMA Engine 275 receives a read-request signal including a channel identifier that identifies a particular channel forwarded from the Synchronous Transmit Frame Processor 280. In response to the read request, the Synchronous Transmit DMA Engine 275 returns a segment of data to the Synchronous Transmit Frame Processor 280.

The Synchronous Transmit DMA Engine 275 reads data from the Jitter Buffer Management 265 including overhead information, such as a channel identifier, identifying a transmit channel, and other bits from a packet header, such as positive and negative stuff bits. At the beginning of each packet, the Synchronous Transmit DMA Engine 275 writes overhead information from the packet header into a FIFO entry. The Synchronous Transmit DMA Engine 275 also sets a bit indicating the validity of the information being provided. For example, if data was not available to fulfill the request (e.g., if the requested packet from the packet stream had not been received), the validity bit would not be set, thereby indicating to the Synchronous Transmit Frame Processor 280 that the data is not valid. The Synchronous Transmit DMA Engine 275 fills the FIFO by writing the data acquired from the Jitter Buffer 270.

The Synchronous Transmit DMA Engine 275 also writes into the FIFO data from the J1 field of the packet header indicating the presence or absence of a J1 byte in the data. Generally, the J1 byte will not be in every packet of a packet stream as the SONET frame size is substantially greater than the packet size. In one embodiment, an overhead bit indicates that a J1 byte is present. If the J1 byte is present, the Synchronous Transmit DMA Engine 275 determines an offset field indicating the offset of the J1 byte from the most-significant byte in the packet data field.

The Synchronous Transmit Frame Processor 280 provides data for all payload bytes, such as all SPE byte locations in the SONET frame, as well as selected overhead or control bytes, such as the H1, H2 and H3 transport overhead bytes. The Synchronous Transmit Telecom Bus 285 provides predetermined null values (e.g., a logical zero) for all other transport overhead bytes. The Synchronous Transmit Frame Processor 280 also generates SONET pointer values (H1 and H2 transport overhead bytes) for each path based on the received J1 offset for each channel. The generated pointer value is relative to the SONET frame position—the Synchronous Transmit Telecom Bus 285 provides a SONET frame reference for this purpose. The Synchronous Transmit Frame Processor 280 also plays out a per-channel user configured byte pattern when data is missing due to a lost packet.

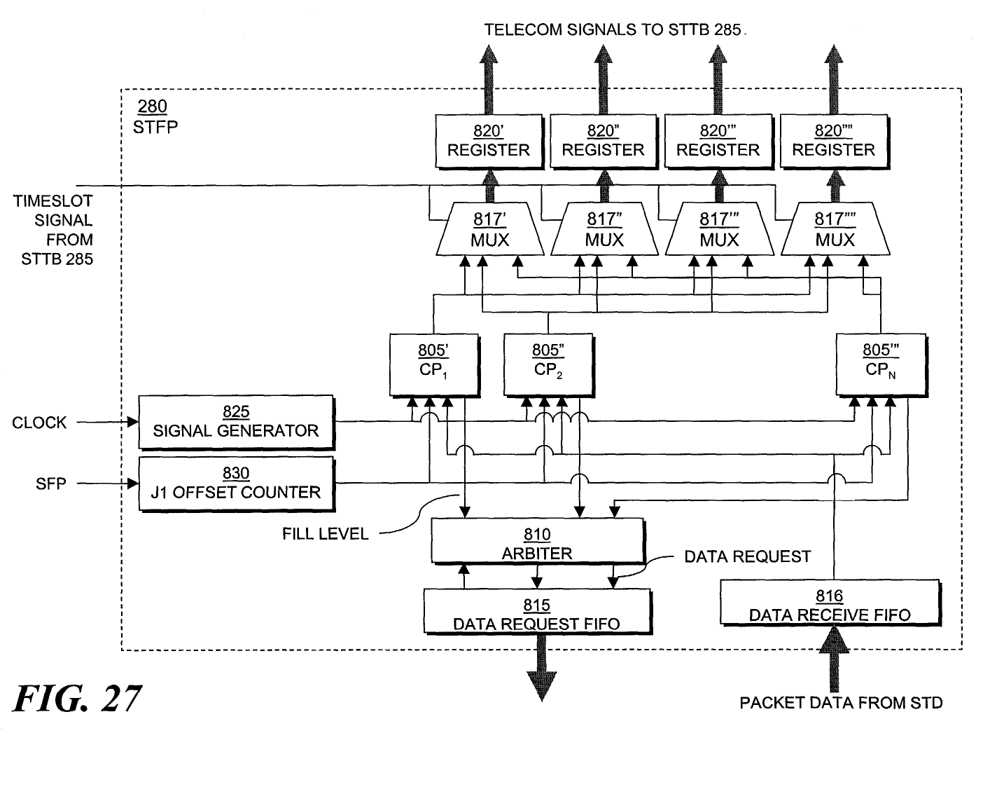

Referring to FIG. 27, the SONET Transmit Frame Processor (STFP) 280 receives packet data from the Synchronous Transmit DMA Engine 275, processes the packet data, converting it into one or more channel signals, and forwards the channel signal(s) to the Synchronous Transmit Telecom Bus 285. In one embodiment, the Synchronous Transmit Frame Processor 280 includes a number of substantially identical transmit Channel Processors 805′, 805″, 805′″ (generally 805), one transmit Channel Processor 805 per channel, allowing the Synchronous Transmit Frame Processor 280 to accommodate up to a predetermined number of channels. In general, the transmit Channel Processors 805 perform a similar operation as that performed by the receive Channel Processors 355, but in the reverse sense. That is, each transmit Channel Processors 805 receives a stream of packets and converts the stream of packets into a channel signal. Generally, the number of transmit channel processors 805 is at least equal to the number of receive Channel Processors 355 ensuring that the System 100 can accommodate all packetized channels received from the Network 115.

Each transmit channel processors 805 transmits a memory-fill-level signal to an arbiter 810. In one embodiment, the arbiter 810 receives at individual input ports the memory fill level from each of the transmit Channel Processors 805. In this manner, the arbiter may distinguish among the transmit Channel Processors 805 according to the corresponding input port. The arbiter 810, in turn, writes a data request signal into a Data Request FIFO 815. The Data Request FIFO 815 transmits a FIFO full signal to the arbiter 810 in response to the FIFO 815 being filled. The Synchronous Transmit DMA Engine 275 reads the data request from the Data Request FIFO 815 and writes packet data to a Data Receive FIFO 816 in response to the data request. The packet data written into the Data Receive FIFO 816 includes a channel identifier. Each of the transmit Channel Processors 805 reads data from the data receive FIFO 816, however, the only transmit Channel Processor 805 that will process the data are those identified by a channel identifier within the packet data.

Each of the transmit Channel Processor 805 transmits the processed channel signal to at least one multiplexer (MUX) 817 (e.g., an N-to-1 multiplexer). Each of the MUX 817 and each of the transmit channel processors 805 also receives a time-slot signal from the Synchronous Transmit Telecom Bus 285. The MUX 817 transmits one of the received channel signals in response to the received time-slot signal. Generally, the Synchronous Transmit Frame Processor 280 includes one MUX 817 for each output signal-stream of the Synchronous Transmit Frame Processor 280 each MUX 817 receiving inputs from all transmit Channel Processors 805. In the illustrative embodiment, the Synchronous Transmit Frame Processor 280 includes four MUXS 817 transmitting four separate output signal-streams to the Synchronous Transmit Telecom Bus 285 through a respective register 820′, 820″, 820′″, 820″″ (generally 820). The registers 820 hold the data and provide an interface to the Synchronous Transmit Telecom Bus 285. For example, the register 820 may hold outputs at predetermined values (e.g., a logical zero value, or a tri-state value) when newly received data is unavailable.

The Synchronous Transmit Frame Processor 280 includes a signal generator 825 transmitting a timing signal to each of the transmit Channel Processors 805. In the illustrative embodiment, the signal generator 825 is a modulo-12 counter driven by a clock signal received from the destination telecom bus. The modulo-12 counter corresponds to the number of channel processors associated with the output signal stream—for example, the twelve channel processors associated with each of four different output signal streams in the illustrative embodiment.

The Synchronous Transmit Frame Processor 280 also includes a J1-Offset Counter 830 for SONET applications transmitting a signal to each of the transmit Channel Processors 805. Each transmit Channel Processor 805 uses the J1-offset counter to identify the location of the J1 byte in relation to a reference byte (e.g., the SONET H3 byte). The transmit Channel Processors 805 may determine the relationship by computing an offset value as the number of bytes between the byte-location of the J1 byte and the reference byte.

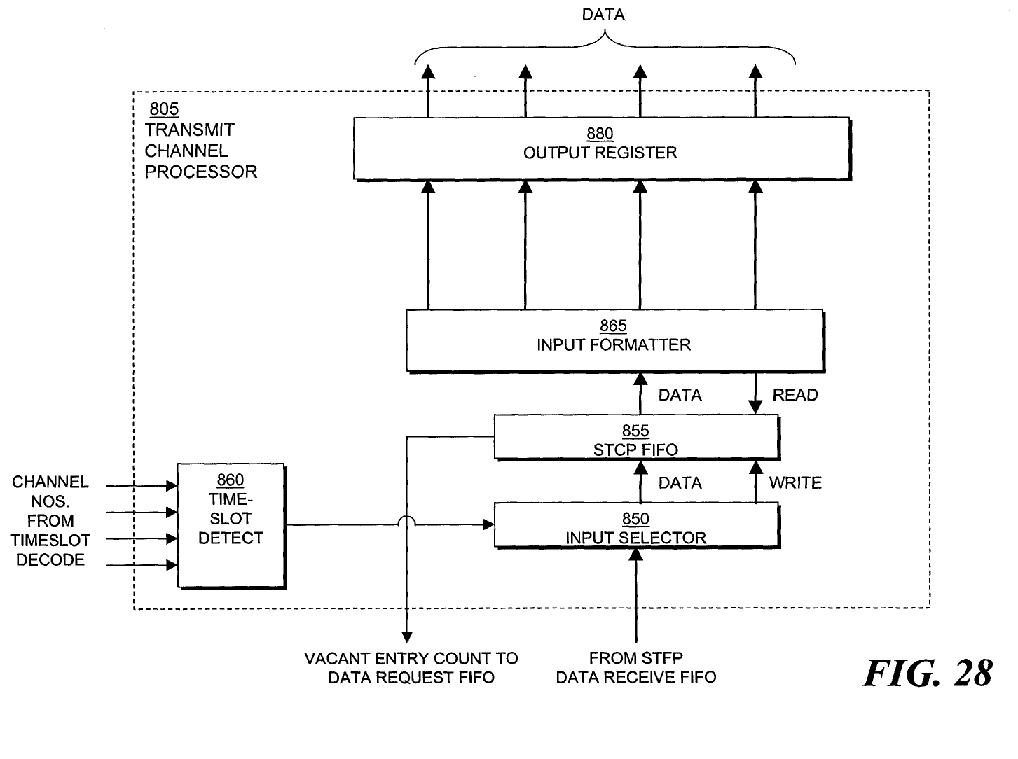

Referring now to FIG. 28, the transmit Channel Processor 805, in more detail, includes an input selector 850 receiving data read from the Data Receive FIFO 816. The Input Selector 850 is in communication with a SONET Transmit Channel Processor (STCP) FIFO 855 writing the data from the input selector 850 into the STCP FIFO 855 in response to receiving a FIFO write command from the input selector 850. The SONET Transmit Channel Processor FIFO 855, in turn, transmits a vacant entry count signal to the arbiter 810 indicating the transmit channel processor memory fill level. The input selector 850 also receives an input from a timeslot detector 860. The timeslot detector 860, in turn, receives timeslot identifiers from the Synchronous Transmit Telecom Bus 285 identifying transmit Channel Processors 805 and transmits the output to the Input Selector 850 in response to a channel processor identifier matching the identity of the transmit channel processor 805. An input formatter 865 reads data from the STCP FIFO 855 and reformats the data, as necessary, for example packing data into 8-byte entries, where less than 8 bytes of valid data are read from the DATA Receive FIFO 816. An output register 880 temporarily stores data being transmitted from the transmit Channel Processor 805.

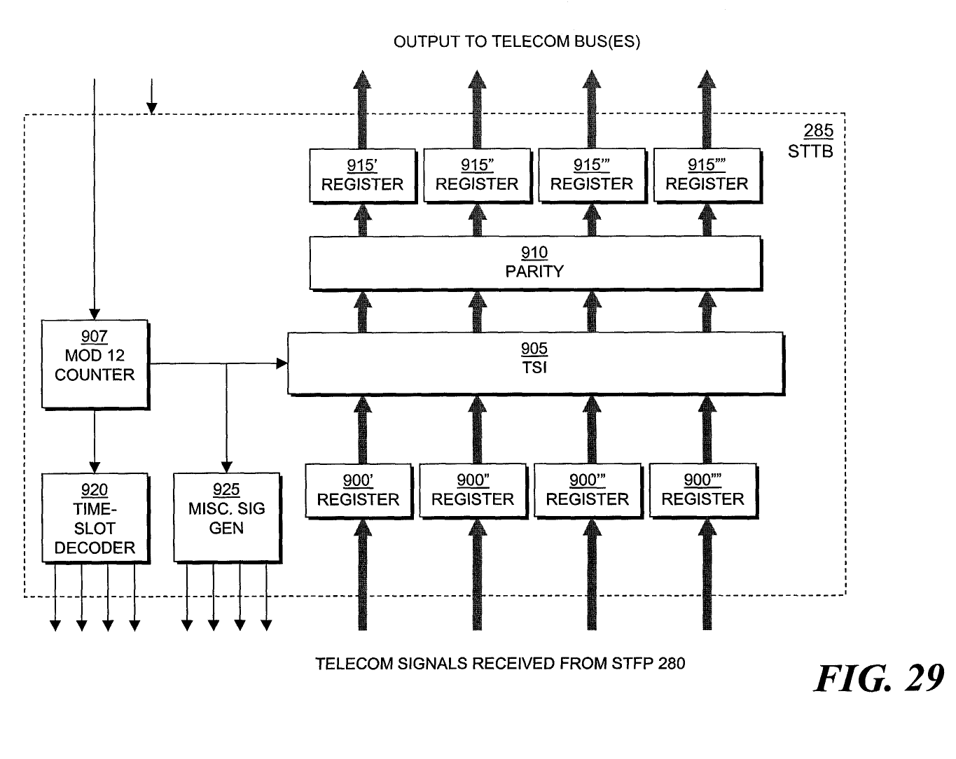

Referring now to FIG. 29, the Synchronous Transmit Telecom Bus 285 receives data and signals from the Synchronous Transmit Frame Processor 280 and transmits data and control signals to one or more telecom busses. The Synchronous Transmit Telecom Bus 285 also provides temporal alignment of the signals to the telecom bus by using a timing reference signal, such as the input J0REF signal. The Synchronous Transmit Telecom Bus 285 also provides parity generation on the outgoing data and control signals, and performs a timeslot interchange, or reordering, on outgoing data similar to that performed by the Synchronous Receive Telecom Bus Interface 200 on the incoming data. The Synchronous Transmit Telecom Bus 285 also transmits a signal, or an idle code, for those timeslots that are unconfigured, or not associated with a transmit Channel Processor 805.

The Synchronous Transmit Telecom Bus 285 includes a group of registers 900′, 900″, 900′″, 900″″ (generally 900) each receiving signals from the Synchronous Transmit Frame Processor 280. Each register 900 may include a number of storage locations, each storing a portion of the received signal. For example, each register 900 may include eight storage locations, each storing one bit of a byte lane. A Time Slot Interchange (TSI) 905 reads the stored elements of the received signal from the registers 900 and performs a reordering of the timeslots, or bytes according to a predetermined ordering. In general, the TSI 905 is constructed similar to the TSI 305 illustrated in FIG. 10. Each TSI 305, 905 can independently store preferred timeslot orderings such that the TSI 305, 905 may implement independent timeslot ordering.

The TSI 905 receives a timing and control input signal from a signal generator, such as a modulo-N counter 907. In one embodiment, a timing and control signal from a modulo-12 counter 907 is selected to step through each of twelve channels received on one or more busses. The modulo-12 counter 907, in turn, receives a synchronization input signal, such as a clock signal, from the telecom bus. The TSI 905 transmits the reordered signal data to a parity generator 910. The parity generator calculates parity for the received data and signals and transmits a parity signal to the telecom bus. The parity generator 910 is in electrical communication with the telecom bus through a number of registers 915′, 915″, 915′″, 915″″ (generally 915). The registers 915 temporarily store signals being transmitted to the telecom bus. The registers 915 may also contain outputs that may be selectively isolated from the bus (e.g., set to a high-impedance state), for example, when one or more of the registers is not transmitting data.

The Synchronous Transmit Telecom Bus 285 also includes a time-slot decoder 920. The Time Slot Decoder 920 receives an input timing and control signal from a signal generator, such as the modulo-12 counter 907. The Time Slot Decoder 920 transmits output signals to each of the transmit Channel Processors 805. In general, the Time Slot Decoder functions in a similar manner to the Time Slot Decoder 360 discussed in relation to FIGS. 11 and 12. The Time Slot Decoder 920 includes one or more timeslot maps for each of the channels, the timeslot maps storing a relationship between the timeslot location and the channel assignment. In some embodiments, the timeslot maps of the Time Slot Decoders 360, 920 include different channel assignments.

The Synchronous Transmit Telecom Bus 285 also includes a miscellaneous signal generator 925 generating signals in response to receiving the timing and control signal from the modulo-12 counter 907. In operation, the Synchronous Transmit Telecom Bus 285 increments through each storage entry in the channel timeslot map, outputting the stored channel number associated with each timeslot. The Synchronous Transmit Frame Processor 280 responds by passing data associated with that channel to the Synchronous Transmit Telecom Bus 285. Based on the current state of the signals output by the Synchronous Transmit Telecom Bus 285, such as H1, H2, H3 signals relating to the J1 byte location, and a SPE_Active signal indicating that transfer bytes are SPE bytes, the Synchronous Transmit Frame Processor 280 will output the appropriate data for that channel. Note that in structured mode of operation, the Synchronous Transmit Frame Processor 280 channels will output zeros for all transport overhead bytes except for H1, H2 and H3.

The miscellaneous signals output to the Synchronous Transmit Frame Processor 280 (SFP, SPE782, H1, H2, H3, PSO, SPE_Active) indicate what bytes should be output at what time. These signals may be generated from an external reference, such as a SONET J0-reference signal (OJ0REF), however, the external reference does not need to be present in every SONET frame. If an external reference is not present, the Synchronous Transmit Frame Processor 280 uses an arbitrary internal signal. In either case, the miscellaneous signals are generated from the reference, and adjusted for timing delay in data being presented to the Synchronous Transmit Frame Processor 280, the turnaround time within the Synchronous Transmit Frame Processor 280, and the delay associated with the TSI 905. Thus, at the point when a particular byte needs to be output to the outgoing telecom bus, it will be available as the output from the TSI 905.

### EXAMPLE

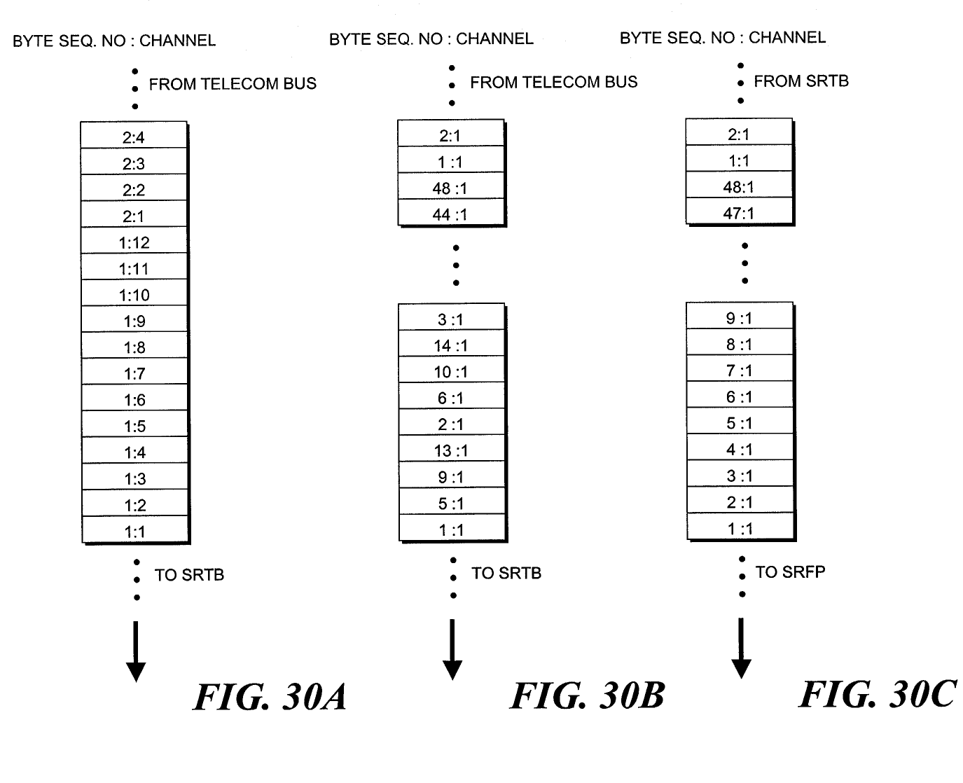

By way of example, referring to FIG. 30A, a representation of the source-telecom bus signal at one of the SRTB input ports 140 is shown. Illustrated is a segment of a telecom signal data stream received from a telecom bus. The blocks represent a stream of bytes flowing from telecom bus to the Synchronous Receive Telecom Bus Interface 200. The exemplary bytes are labeled reflecting relative byte sequence numbers (e.g., 1 to 12) and a channel identifier (e.g., 1 to 12). Accordingly, the notation “2:4” used within the illustrative example indicates the 2^{nd} byte in the sequence of bytes attributed to channel four. The signal stream illustrated may represent an STS-12 signal in which twelve STS-1 signals are interleaved as earlier discussed in relation to FIG. 3.

Referring to FIG. 30B, a second illustrative example reflects the telecom signal data stream for a single STS-48 including a non-standard byte (timeslot) ordering. The TSI 305 may be configured to reorder the bytes received in the exemplary, nonstandard sequence into a preferred sequence, such as a SONET sequence illustrated in FIG. 30C. Ultimately, the Timeslot Decoder 360 transmits signals to the receive Channel Processors 355 directing individual receive Channel Processors 355 to accept respective channels of data from the reordered signal stream illustrated in FIGS. 30A, 30C.

Having shown the preferred embodiments, one skilled in the art will realize that many variations are possible within the scope and spirit of the claimed invention. It is therefore the intention to limit the invention only by the scope of the claims.

What is claimed is:

1. A method for emulating a synchronous transport signal across a packet-oriented network, the method comprising the steps of:
(a) receiving data representative of a synchronous transport signal at each of a plurality of channel processors;
(b) creating a plurality of packets using the data, each of the plurality of packets having a header conforming to the protocol of a packet-oriented network;
(c) transmitting the plurality of packets via the packet-oriented network;
(d) storing each of the received plurality of packets in a respective memory element associated with one of the plurality of channel processors;
(e) receiving telemetry data representative of packet traffic; and
(f) adjusting timing of the synchronous transport signal based on the received telemetry data.

2. The method of claim 1, wherein the channel processors of step (a) comprise one of physical channel processors, and logical channel processors, and combinations thereof.

3. The method of claim 1, wherein step (a) comprises receiving a data representative of a SONET signal, at each of a plurality of channel processors.

4. The method of claim 1, wherein step (b) comprises creating a plurality of packets conforming to the protocol of an IP network.

5. The method of claim 1, wherein step (b) comprises creating a plurality of packets conforming to a packet protocol selected from the group comprising PPP, MPLS, ATM, Ethernet, RPR, GFP.

6. The method of claim 1, wherein step (d), the plurality of memory elements comprise a plurality of ring buffers.

7. The method of claim 1, wherein step (e) comprises counting a number of packets written into the memory, a number of packets played out of the memory element, and a number of packets lost in transit.

8. The method of claim 1, wherein step (e) comprises making a pointer adjustment for the SONET signal based on the telemetry data representative of packet counts.

9. The method of claim 8, wherein step (e) comprises the steps:
(e-1) processing the telemetry data determining a timing adjust signal; and
(e-2) making a pointer adjustment for the SONET signal based on the timing adjust signal.

10. The method of claim 9, wherein step (e-2) comprises making a positive pointer adjustment for the SONET signal based on the timing adjust signal indicative of local timing being too fast.

11. The method of claim 9, wherein step (e-2) comprises making a negative pointer adjustment for the SONET signal based on the timing adjust signal indicative of local timing being too slow.

12. The method of claim 9, wherein the processing of step (e) comprises digital signal processing.

13. The method of claim 12, wherein digital signal processing comprises a series lead compensator with a negative unity output feedback, wherein the series lead compensator is configured by a plurality of parameters.

14. The method of claim 13, wherein digital signal processing comprises an acquisition mode, a tracking mode, and a holdover mode, the acquisition mode allowing for a rapid acquisition of synchronization at startup, the tracking mode providing for substantial noise rejection during steady-state operation, and the holdover mode refraining from processing new data.

15. The method of claim 8, wherein step (e) comprises the steps:
(e-1) processing the telemetry data to determine a timing adjust signal; and
(e-2) controlling a controllable timing source based on the timing adjust signal.

16. The method of claim 15, wherein step (e-2) comprises providing a voltage control signal to a Voltage Controlled Frequency Oscillator (VCXO).

17. The method of claim 15, further comprising the step of digital-to-analog converting the timing adjust signal.

18. An apparatus for emulating a synchronous transport signal across a packet-oriented network comprising:
(a) a plurality of channel processors, each receiving data representative of a synchronous transport signal;
(b) a packet processor to create a plurality of packets using the data, each of the plurality of packets having a header conforming to the protocol of a packet-oriented network;
(c) a transmitter to transmit the packets over the packet-oriented network;
(d) a plurality of memory elements, each associated with a respective one of the plurality of channel processors for storing a respective one of the received plurality of packets;
(e) a receiver to receive telemetry data representative of packet traffic; and
(f) a timing adjuster to adjust the timing of the synchronous transport signal based on the received telemetry data, wherein the received telemetry data is representative of a packet count selected from the group comprising: packets received, packets played, and packets dropped, while accounting for mis-ordered packets.

19. The apparatus of claim 18, wherein the timing adjuster comprises:
a counter counting packets selected from the group comprising: packets played, packets dropped, while accounting for mis-ordered packets;
a Digital Signal Processor (DSP) in communication with the counter periodically receiving a number of packets counted, wherein the DSP generates a timing adjust signal based on the received packet count;
a Voltage-Controlled Frequency Oscillator (VCXO) receiving the timing adjust signal from the digital signal processor.

20. The apparatus of claim 19 further comprising a Digital-To-Analog Converter (DAC) in communication with the DSP and the VCXO receiving the timing adjust signal from the DSP and transmitting an analog representation of the timing adjust signal to the VCXO.
